(19) United States
(12) Patent Application Publication
(10) Pub. No.: US 2005/0030444 A1
(43) Pub. Date: Feb. 10, 2005

(54) Liquid crystal display

(75) Inventors: Isao Fujiwara, Kanagawa (JP); Keiichi Miyazaki, Kanagawa (JP)

Correspondence Address: BURNS DOANE SWECKER & MATHIS L L P, POST OFFICE BOX 1404, ALEXANDRIA, VA, 22313-1404, US

(73) Assignee: Fuji Photo Film Co., Ltd., Minami-Ashigara-shi (JP)

(21) Appl. No.: 10/880,471

(22) Filed: Jul. 1, 2004

(30) Foreign Application Priority Data
Jul. 2, 2003 (JP) 2003-190190

(51) Int. Cl. G02F 1/1335

(52) U.S. Cl. 349/64

(57) ABSTRACT

The liquid crystal display of the present invention comprises a backlight, an anisotropic scattering film having different scattering properties depending on incident angles, a liquid crystal cell comprising liquid crystals sandwiched between two facing substrates, polarizing plates respectively disposed on the backlight side and visual recognition side of the liquid crystal cell, and at least one optical diffusion film on the visual recognition side of the liquid crystal cell. A difference H(θ)−H(0) between the haze H(θ) of the anisotropic scattering film for incident light at a gray scale inversion angle θ of the liquid crystal cell, and the haze H(0) for incident light from the normal direction of this anisotropic scattering film is 5% to 100%, and the anisotropic scattering film is disposed between the backlight and the liquid crystal cell.

### BACKGROUND OF THE INVENTION

1. Field of the Invention

The present invention relates to a highly efficient transmitting type liquid crystal display which can prevent downward gray scale inversion of a liquid crystal panel, considerably improve a visual angle property, and prevent reflection of stray light.

2. Description of the Related Art

In general, a liquid crystal display comprises a polarizing plate and a liquid crystal cell. One of the defects in the display quality of this liquid crystal display, is a narrow visual angle and reflection of stray light, and it was desired to develop a liquid crystal display without these faults.

As to the visual angle dependence of TN mode TFT liquid crystal displays which are the most common today, it is known that by inserting an optical compensation film between the polarizing plate and the liquid crystal cell, the visual angle can be expanded (“Liquid Crystal Display Introduction Lecture No. 11: Technique of Expanding Visual Angle of a TFT-LCD by a Discotic Optical Compensation Film”, Hiroyuki Mori, Liquid Crystals, Vol. 6, No. 1, p. 84, 2002). However, in this liquid crystal display, there is the fault that downward gray scale inversion of the liquid crystal panel occurs, or the hue changes with the visual angle.

In order to solve this problem, a method of using an optical compensation film together with an optical diffusion layer has been proposed (Japanese Patent Application Laid-Open (JP-A) No. 10-10513). According to this proposal, it is reported that although visual angle dependence improves to some extent, there is a fall of front contrast (normal direction) and a decline in the clarity of the transmitted image.

A method has been proposed of using an optical compensation film and an anisotropic scattering element which gives the strongest scattered light in the direction of a downward gray scale inversion angle of the TN-LCD (JP-A No. 2002-90527). However, also in this case, as the gray scale inversion angle is not very wide, there is considerable reflection of stray light and the hue changes with the visual angle.

In a liquid crystal display, when the radiation angle of the backlight used as the light source is wide, as the gray scale inversion angle does not widen even if an optical diffusion film is used, it was for example proposed to use a light collecting plate between the backlight and liquid crystal cell, and a diffusion plate on the visual recognition side of the liquid crystal cell, so that their directionalities were respectively reversed (JP-A No. 10-153772). According to this proposal, the gray scale inversion angle can be widened, but the front luminosity decreases, and the luminosity variation when the visual angle from the front surface was changed, is not smooth.

Also, in reflecting type liquid crystal displays, an anisotropic scattering film is used on the visual recognition side of the liquid crystal cell. For example, a reflecting type liquid crystal display was proposed which, for example, has scattering properties at the incident angle of incoming stray light and transmittivity to light at other angles, so there is not much dependence on bright usage environments (JP-A No. 2000-275408).

Thus, in both the transmitting type and the reflecting type liquid crystal display, by disposing an anisotropic scattering film on the visual recognition side of the liquid crystal cell so that the light amount in the emitted light distribution from the liquid crystal cell is selectively scattered in a direction where there is less light, the emitted light distribution is equalized, and visual angle properties are improved. However, even if the anisotropic scattering film was disposed on the visual recognition side of the liquid crystal cell so that the emitted light distribution was equalized and visual angle dependence was improved, downward gray scale inversion of the liquid crystal panel could not be prevented.

A transmitting type liquid crystal display has been proposed wherein an anisotropic scattering film is disposed between the backlight and liquid crystal cell to vary the directionality of the emitted light distribution from the backlight (JP-A No. 2000-171619). However, in this proposal, an optical diffusion film is not disposed on the visual recognition side of the liquid crystal cell, so there is no widening of the gray scale inversion angle.

Therefore, a liquid crystal display wherein the downward gray scale inversion angle of a liquid crystal panel is widened, the visual angle property is largely improved, the reflectance of stray light is improved and defects in the display quality are resolved, had not yet been provided.

### SUMMARY OF THE INVENTION

It is therefore an object of the present invention to provide a transmitting type liquid crystal display which prevents downward gray scale inversion of a liquid crystal panel, considerably improves visual angle properties, prevents reflection of stray light, and improves front contrast and image clarity.

As a result of the Inventor's detailed examination aimed at resolving this problem, the following observations were made. Specifically, it was found that there was a negative correlation between the gray scale inversion improvement effect in a liquid crystal display having an optical diffusion film on the visual recognition side of the liquid crystal cell, and the incident light amount at a wider angle than the gray scale inversion angle of the liquid crystal cell. It was also found that the gray scale inversion angle widens, the fewer the components in the light incident to the liquid crystal cell at an angle larger than the gray scale inversion angle of the liquid crystal cell, are.

Although many techniques have been proposed to collect backlight, there were so far no techniques which took account of the gray scale property of the liquid crystal cell, and which, in order to reduce light at an angle larger than the angle at which gray scale inversion occurs, ensure that the light emitted from the backlight at an angle larger than the angle at which gray scale inversion occurs, is dispersed in another direction. It was also found that by controlling the haze value of the optical diffusion film on the visual recognition side of the liquid crystal cell and laminating a low refractive index layer on this optical diffusion film, reflection of stray light could be prevented and visual field angle improved without sacrificing the blurring of the image.

However, if the incident light on the wide angle side is severely decreased taking the gray scale inversion angle as a borderline as described above, the luminosity variation largely increases when the visual angle is inclined, and the display quality deteriorates. On the other hand, if the directivity of the incident light to the liquid crystal cell is narrowed and light is scattered too much by the optical diffusion film on the visual recognition side, back scattering becomes large, front luminosity decreases and image clarity deteriorates. Therefore, it was found that it is important to control the light incident to the liquid crystal cell and the scattered light intensity distribution of the optical diffusion film to within a certain range.

As a result of further studies performed by the Inventor based on these observations, it was found that to attain the desired visual recognition properties, it was effective to provide an optical diffusion film on the visual recognition side of the liquid crystal cell, and to provide an anisotropic scattering film between the backlight and liquid crystal cell for which a difference H(θ)−H(0) between the haze H(θ) relative to incident light at a gray scale inversion angle θ of the liquid crystal cell, and the haze H(0) relative to incident light from the normal direction of this anisotropic scattering film, lies within a fixed range.

In the liquid crystal display of the present invention, the liquid crystal display comprises a backlight, an anisotropic scattering film having different scattering properties depending on incident angles, a liquid crystal cell containing liquid crystals sandwiched between two facing substrates, polarizing plates respectively disposed on the backlight side and visual recognition side of the liquid crystal cell, and at least one optical diffusion film on the visual recognition side of the liquid crystal cell, and the gray scale inversion angle of the liquid crystal display can be improved by disposing, between the backlight and liquid crystal cell, an anisotropic scattering film for which the difference H(θ)−H(0) between the haze H(θ) for light incident at a gray scale inversion angle θ of the liquid crystal cell, and the haze H(0) for light incident from the normal direction of this anisotropic scattering film, is from 5% to 100%. Further, the gray scale inversion angle of the liquid crystal display can be largely improved by providing an optical diffusion film for which the scattered light intensity at 30° relative to the light intensity at an emission angle of 0° in the scattered light angle distribution on the visual recognition side of the liquid crystal cells, is from 0.01% to 0.2%, and the haze H(0) is 40% or more. As a result, the visual angle properties can be considerably improved, reflection of stray light can be prevented, and a high performance transmission type liquid crystal display having enhanced front contrast and image clarity can be provided.

### BRIEF DESCRIPTION OF THE DRAWINGS

FIG. 1 is a cross-sectional view showing an example of the construction of a liquid crystal display device according to the present invention.

FIG. 2 is a cross-sectional view showing an example of an optical diffusion film according to the present invention.

FIG. 3A is a cross-sectional view showing an example of the structure of a liquid crystal display.

FIG. 3B is a light source unit perspective view.

FIG. 4 is a schematic view of a liquid crystal display wherein the gray scale inversion angle has been measured.

FIG. 5A is a graph showing a gray scale inversion angle measurement result (luminosity distribution in the up/down direction). FIG. 5B is an enlargement of the elements of FIG. 5A.

FIG. 6 is a graph which logarithmically displays the gray scale inversion angle measurement result (luminosity distribution in the up/down direction) of FIG. 5A.

FIG. 7 is a scattering profile (gaps between concentric circles are shown logarithmically) of an optical diffusion film (A-02).

FIG. 8 is a structural diagram showing the liquid crystal display of a first example.

FIG. 9 is a structural diagram showing the liquid crystal display of a second example.

FIG. 10 is a structural diagram showing the liquid crystal display of a third example.

FIG. 11 is a structural diagram showing the liquid crystal display of a Comparative Example 1.

FIG. 12 is a structural diagram showing the liquid crystal display of a Comparative Example 2.

FIG. 13 is a structural diagram showing the liquid crystal display of a Comparative Example 3.

FIG. 14 is a structural diagram showing the liquid crystal display of a Comparative Example 4 (prior art).

### DESCRIPTION OF THE PREFERRED EMBODIMENTS

The liquid crystal display of the present invention comprises a backlight, an anisotropic scattering film, a liquid crystal cell, a polarizing plate and an optical diffusion film, and comprises other members if required.

In this anisotropic scattering film, the difference H(θ)−H(0) between the haze H(θ) for light incident at a gray scale inversion angle θ of the liquid crystal cell, and the haze H(0) for light incident from the normal direction of this anisotropic scattering film, is from 5% to 100%, and this anisotropic scattering film is disposed between the backlight and the liquid crystal cell.

In this specification, the notation “1” to “2” means “one or more, and two or less.”

Herein, an example of the liquid crystal display of the present invention will be described referring to the drawings.

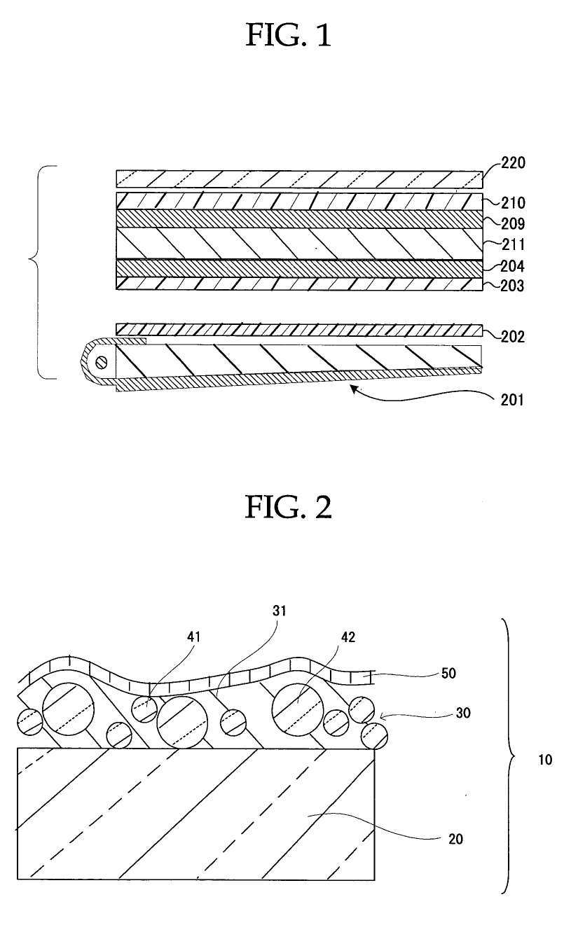

The liquid crystal display shown in FIG. 1 has a backlight unit 201 comprising various optical sheets, an anisotropic scattering film 202 whereof the scattering properties differ depending on the incident light, a liquid crystal cell 211 comprising liquid crystals between two substrates which face each other, polarizing films 203, 210 respectively disposed on the backlight side and visual recognition side of this liquid crystal cell, optically anisotropic layers 204, 209, and an optical diffusion film 220 on the visual recognition side of the liquid crystal cell.

The anisotropic scattering film may be in any position as long as it is between the backlight and the liquid crystal cell, but in the case of a set of optical sheets, it is preferably disposed on the visual recognition side. Also, at least one optical diffusion film is preferably disposed on the uppermost surface on the visual recognition side of the liquid crystal cell.

In the liquid crystal display of the present invention, in the anisotropic scattering film, the difference H(θ)−H(0) between the haze H(θ) for light incident at a gray scale inversion angle θ of the liquid crystal cell, and the haze H(0) for light incident from the normal direction of this anisotropic scattering film, is from 5% to 100%, more preferably 10% to 100%, still more preferably 15% to 100% and most preferably 30% to 100%.

If the difference H(θ)−H(0) is less than 5%, the dependence of the scattering property on the incident angle is small, and the directivity of the light which passed through the film may not be different from before passage. However, the difference H(θ)−H(0) usually does not exceed 100%.

Here, the haze value can be measured using for example an Automatic Variation Angle photometer GP-5 manufactured by Murakami Color Research Laboratory.

In the liquid crystal display of the present invention, the scattered light intensity of the optical diffusion film disposed on the visual recognition side of the liquid crystal cell at 30° relative to the light intensity at an emission angle of 0° in the scattered light angle distribution on the visual recognition side of the liquid crystal cell, is preferably from 0.01% to 0.2%, and the haze H(0) is preferably 40% or more. The scattered light intensity of the optical diffusion film at 30° relative to the light intensity at an emission angle of 0° in the scattered light angle distribution is more preferably from 0.02% to 0.15%, and still more preferably 0.03 to 0.1%.

If the scattered light intensity at 30° relative to the light intensity at an emission angle of 0° is less than 0.01%, sufficient scattering properties to resolve the gray scale inversion may not be obtained, and if it exceeds 0.2%, the scattered light amount increases so that image clarity may fall due to blurring of the image.

When the optical diffusion film is disposed on the uppermost layer on the visual recognition side, a low refractive index layer having a refractive index of 1.35 to 1.45 is preferably provided on this optical diffusion film. If the refractive index exceeds 1.45, the refractive index difference from the refractive index of the optical diffusion film may be small, and the anti-reflection function may fall. On the other hand, it is difficult to manufacture a low refractive index layer having a refractive index of less than 1.35 due to material limitations.

From the viewpoint of enhancing image quality, the scattered light intensity in the 60° direction which is correlated with image blurring is preferably controlled. Also, the scattered light intensity at an angle of 60° relative to the light intensity at an emission angle of 0° in the scattered light angle distribution of the optical diffusion film is preferably 0.02% or less, more preferably 0.01% or less and still more preferably 0.005% or less.

Herein, the scattered light profile can be measured using for example the Automatic Variation Angle Photometer GP-5 manufactured by Murakami Color Research Laboratory.

In order to improve gray scale inversion angle properties, it is also important to control the haze value of the optical diffusion film. For the internal scattering haze of the optical diffusion film, the haze is preferably 30 to 80%, more preferably 35 to 70% and still more preferably 40 to 60%.

Further, in the optical diffusion film, it is also preferred to provide haze due to surface unevenness from the viewpoint of improving visibility, and in the state where both internal scattering haze and surface haze are present, the haze value is preferably 40% or more, preferably 40 to 90%, more preferably 45 to 80% and still more preferably 50 to 70%. This allows a visual angle improvement effect to be obtained.

Herein, the haze value can be measured according to JIS-K7105, for example using HR-100 manufactured by Murakami Color Research Laboratory, and Haze Meter MODEL 1001DP (manufactured by Nippon Denshoku Industries Co., Ltd.).

Hereafter, the layers forming the transmitting type liquid crystal display will be described in detail.

<Anisotropic Scattering Film>

The anisotropic scattering film may for example be:
(i) a film for which the scattering properties are different in two scattering planes perpendicular to the incidence direction, or
(ii) a film for which the scattering properties are different depending on the light incident angle, but in the present invention, the anisotropic scattering film is a film which at least has the properties of (ii).

The anisotropic scattering film has scattering anisotropy with respect to the polar angle (incident angle). The azimuthal angle component may have anisotropy with respect to a certain polar angle (for example, a polar angle of 30°), or it may not.

Specifically, when the haze for light which was incident at an arbitrary azimuthal angle φ relative to a polar angle of 30° is set to H(30, φ), the difference between the haze H(30, φ+90) and the haze H(30, φ) may be 0%, or may not be 0%. Also, the difference of the haze H(30, φ) and the haze H(30, φ+180) may be 0%, or may not be 0%.

The anisotropic scattering film is not particularly limited provided that the difference H(θ)−H(0) between the haze H(0) for light incident from the normal direction (0°) to the film surface, and the haze H(θ) for light incident at a gray scale inversion angle θ of the liquid crystal cell used in conjunction therewith, is 5% to 100%, as mentioned above, and may be suitably selected according to the purpose.

However, in scattering using isotropic surface unevenness or particles, as it is difficult to introduce incident angle (polar angle) dependence into the scattering properties, in the aforesaid anisotropic scattering film, it is preferred that parts having a different refractive index are present in the interior of the film at an irregular pitch, that the structure formed by refractive index maxima and minima is laminar or cylindrical, and that the structure is such that the refractive index distributed at 0° or at an inclination to the thickness direction of the film is non-uniform.

In order to form the aforesaid non-uniform refractive index structure, two or more sorts of optical crosslinking monomers or oligomers of mutually different refractive indices are preferably used. The optical crosslinking functional group may for example be a vinyl group, vinyl oxy-group, acryloyl group or methacryloyl group. To form the non-uniform refractive index structure, for example, an optical crosslinking material containing the optical crosslinking monomer or oligomer is coated on a support, and ultraviolet radiation (UV) or visible light of 500 nm or less which has been substantially collimated parallel is irradiated through a random mask pattern prepared beforehand. The laminar or cylindrical structure can be controlled by the random mask pattern, size distribution, or incident angle of the irradiation light.

Specific compositions and manufacturing methods are given in JP-A No. 2000-297110 and JP-A No. 2000-297139. In JP-A No. 2002-267812, it is disclosed that in a light scattering layer containing a transparent resin and a scattering material, an anisotropic scattering film which has dependence on the incident angle (polar angle) is obtained when at least one component is formed from a substance having birefringence.

The aforesaid anisotropic film may be a commercial product such as LUMISTY “MFZ-2555” (product name, Sumitomo Chemical Co., Ltd.), a speckled film comprising a film on which speckles have been recorded, or a film comprising an optically transmitting resin wherein the parts of different refractive index are distributed with an irregular shape or thickness. Among these, LUMISTY (product name, Sumitomo Chemical Co., Ltd.) is convenient.

LUMISTY is formed from a resin composition for anisotropic scattering films containing at least two photopolymerizable monomers or oligomers having mutually different refractive indices.

Examples of such photopolymerizable monomers or oligomers are 2,4,6-tribromophenyl acrylate, tribromophenoxyethyl acrylate, 2-hydroxy-3-phenoxypropyl acrylate, tetrahydrofurfuryl acrylate, ethyl carbitol acrylate, pentenyl oxy-ethyl acrylate, phenyl carbitol acrylate, polyol polyacrylate, polyacrylate having an isocyanuric acid skeleton, melamine acrylate, polyacrylate having a hydantoin skeleton and urethane acrylate, as disclosed in JP-A No. 07-64069.

Two or more kinds of the aforesaid photopolymerizable monomers or oligomers having mutually different refractive indices may be used. Examples of such compositions are two kinds selected from monomers, one monomer and one oligomer, two kinds selected from oligomers, or the combinations where one or more monomer or oligomer are added to the aforesaid combinations. In these combinations, to obtain the required light scattering ability, at least two kinds preferably have a refractive index difference of 0.01 or more.

In order to increase the hardenability of the anisotropic scattering film, it is preferred to use a photopolymerization initiator. Examples of such photopolymerization initiators are benzophenone, 2-hydroxy-2-methylpropiophenone, benzil, Michler's ketone or 2-chlorothioxanthone, as disclosed in JP-A No. 07-64069.

In the anisotropic scattering film composition, the photopolymerizable monomer and oligomer have different refractive indices, and can contain a compound which does not have photopolymerization properties. Examples of such compounds which do not have photopolymerization properties are styrene resins such as polystyrene, acrylic resins such as poly(methyl methacrylate), polyethylene oxide resins, polyvinylpyrrolidone and polyvinyl alcohol, and plastic additives such as organohalogen compounds, organosilicon compounds, plasticizers and stabilizers. These can also be blended as a high refractive index component or a low refractive index component into the composition for anisotropic scattering films. The difference of refractive index between the one or more photopolymerizable monomers or oligomers and the compound which has no photopolymerization properties, is preferably 0.01 or more.

To this composition for anisotropic scattering films, 0.01 to 5 mass parts of a filler having an average particle diameter of 0.05 to 20 μm, or a UV absorber, may also be added.

An optical control plate which selectively scatters incident light at a specific angle can be obtained by hardening the anisotropic scattering film composition with the photo-curing device disclosed by JP-A No. 7-64069. A thermosetting mechanism may also be used concurrently within limits which do not affect performance. Preferably, after applying these compositions for example to a substrate, or enclosing them in a cell and forming a film, they are hardened by irradiating with ultraviolet radiation from a specific direction. By this method, an anisotropic scattering film which selectively scatters incident light at a desired angle, can be obtained.

The light source used in the photopolymerization is not particularly limited provided that it emits ultraviolet radiation which contributes to photopolymerization and can be suitably selected according to the purpose, but the shape of the light source may for example be suitably selected according to the light control function required of the anisotropic scattering film. As disclosed in JP-A No. 07-209637, if it is desired to make the light scattering ability of the anisotropic scattering film equal for all azimuths, a parallel light beam such as that of sunlight is the most suitable, but in the case of a sphere, box or pencil-shaped light source wherein the ratio of the length in the long axis direction to the length in the short axis direction of the lamp is 2:1 or less, an equivalent performance can be obtained. If it is desired to confer light scattering properties only in one direction such as from top to bottom or left to right, a pencil-shaped or rod-shaped light source is preferred.

The selective scattering power for the light incident angle of the anisotropic scattering film is specified by the haze value for the light incident angle of the anisotropic scattering film. In the anisotropic scattering film used by the present invention, the haze value preferably varies with the light incident angle, and it preferably has a light incident angle region exhibiting a light scattering ability (scattering angle region) where the haze is 30% or more, and another light incident angle region which does not exhibit light scattering ability where the haze value is less than 30%. From the viewpoint of display clarity, the maximum haze value of the scattering angle region is preferably 30 to 85%.

The thickness of the anisotropic scattering film (not including the transparent substrate for the support) is not particularly limited and can be suitably selected according to the purpose, but for example 1.0 to 20 μm is preferred.

<Optical Diffusion Film>

The aforesaid optical diffusion film is not particularly limited provided that the scattered light intensity at 30° relative to the light intensity at an emission angle of 0° in the scattered light angle distribution is from 0.01% to 0.2%, and the haze H(0) is 40% or more, as mentioned above. It may be suitably selected according to the purpose, but the optical diffusion film for example comprises at least one optical diffusion layer on a transparent substrate, and preferably has a low refractive index layer on this optical diffusion layer.

In the present invention, to improve the downward gray scale inversion angle of the liquid crystal panel, the incident light is preferably scattered to some extent, and the larger the scattering effect is, the more the visual field angle properties improve, but in order to maintain the luminosity of the front panel, it is preferable to increase its transmittivity as far as possible.

Transparent Substrate

The transparent substrate may for example be a transparent resin film, a transparent resin plate, a transparent resin sheet, or clear glass.

The transparent resin film is preferably a plastic film. The polymer used to form this plastic film is not particularly limited and may be selected according to the purpose, examples being cellulose esters (e.g., triacetyl cellulose and diacetyl cellulose, commercial name TAC-TD 80U and TD80UF, Fuji Photo Film Co., Ltd.), polyamide, polycarbonate, polyester (e.g., polyethylene terephthalate and polyethylenenaphthalate), polystyrene, polyolefin, norbornene resin (e.g., ARTON, JSR Corporation) and amorphous polyolefin (e.g., ZEONEX, ZEON CORPORATION). Among these, triacetyl cellulose, polyethylene terephthalate and polyethylenenaphthalate are preferred, but triacetyl cellulose is more preferred.

The thickness of the transparent substrate is not particularly limited and can be suitably selected according to the purpose, but for example about 25 to 1000 μm is preferred.

The single layer triacetyl cellulose may be one of a single layer and a multi-layer type. The single layer triacetyl cellulose may for example be that manufactured by drum casting or band casting disclosed by JP-A No. 07-11055.

The multi-layer triacetyl cellulose may for example be that manufactured by the co-casting method disclosed by JP-A No. 61-94725, and Japanese Patent Application Publication (JP-B)No. 62-43846.

In this co-casting, raw material flakes are dissolved in a solvent such as a halogenated hydrocarbon (e.g., dichloromethane), alcohol (e.g., methanol, ethanol, butanol), ester (e.g., methyl formate, methyl acetate) or ether (e.g., dioxane, dioxolane, diethyl ether). Next, a solution (hereafter, may be referred to as “dope”) is prepared by adding various kinds of additive agents to this solution if required, such as a plasticizer, UV absorber, antidegradant, slide agent and peeling catalyst. When this dope is cast by a dope feeding means (hereafter, may be referred to as “die”) on a support comprising a horizontal endless metal belt or rotating endless drum, if it is a single layer, a single dope is cast, and if it is multi-layer, a low concentration dope is co-cast on both sides of a high concentration cellulose ester dope. The film on the support which is dried to some extent to impart rigidity, is then peeled from the support. Next, it is passed through a drying part by a transportation means to remove solvent.

The solvent for dissolving the triacetyl cellulose is preferably a halogenated hydrocarbon, such as dichloromethane. However, from the viewpoint of avoiding contamination of the global environment or work environment, it is preferred that the solvent effectively does not contain a halogenated hydrocarbon, such as dichloromethane. Herein, “effectively does not contain” means that the ratio of halogenated hydrocarbon in the organic solvent is less than 5% by mass (but more preferably, less than 2% by mass).

In preparing the triacetyl cellulose dope using a solvent which effectively does not contain a halogenated hydrocarbon such as dichloromethane, special dissolution processes, mentioned later, are necessary. These may be referred to as a cooling dissolution process and a high temperature dissolution process. A cellulose acetate film which effectively does not contain a halogenated hydrocarbon such as dichloromethane, and its manufacturing method, are disclosed by a Japan Institute of Invention and Innovation Technical Disclosure (Disclosure No. 2001-1745, issued on 15 March, 2001, referred to hereafter as Technical Disclosure 2001-1745).

When the transparent support is triacetyl cellulose, and for example a tacky adhesive layer is provided on one side to stick on other functional layers or substrates, a saponification is preferably performed. This saponification may be performed by a technique known in the art, for example, by immersing the film in an alkali solution for a suitable time. It is preferable that after being immersed in the alkali solution, it is thoroughly rinsed with water so that the alkali component does not remain on the film, and is then immersed in a dilute acid to neutralize the alkali component.

Due to the aforesaid saponification, the surface of the transparent support on the opposite side to the side with the uppermost layer becomes hydrophilic.

The surface which has become hydrophilic effectively improves adhesion with a deflection film having polyvinyl alcohol as its main component. Moreover, dust in the air does not easily stick to the surface which has become hydrophilic, so dust does not easily enter between this deflection film and an anti-reflection film when it is stuck to the deflection film, which is effective to prevent point defects due to dust.

The aforesaid saponification is preferably performed so that the contact angle with respect to the water on the surface of the transparent support on the opposite side to the side with the uppermost layer is 40° or less, but the contact angle is more preferably 30° or less and still more preferably 20° or less.

The specific means of performing the alkali saponification may be selected from the following two alternatives. Among these, the following (1) is excellent from the viewpoint that processing can be performed by an identical step to that of an ordinary triacetyl cellulose film, but as the saponification treatment extends to the anti-reflection film surface, there are problems in that the surface undergoes alkali hydrolysis so that the film deteriorates, and if the saponification solution remains, soiling occurs. In this case, although it involves a special step, the following (2) is preferably selected:
(1) After forming an anti-reflection layer on the transparent support, the undersurface of the film is given a saponification treatment by immersing at least once in an alkali solution.
(2) Prior to or after forming the anti-reflection layer on the transparent support, an alkali solution is coated on the surface opposite to the surface whereon the anti-reflection film is formed, and the undersurface of the film alone is given a saponification treatment by performing at least one of heating, water rinsing and neutralization.
   Optical Diffusion Layer

The optical diffusion layer contains two or more translucent particles (e.g., first translucent particles and second translucent particles) for which at least one of the refractive index and volume-weighted average particle diameter is different in the translucent resin, and may contain other components if required. The translucent resin may be transparent resin.

The translucent resin is not particularly limited provided that it has translucency, and may be suitably selected according to the purpose, but three types may be used, for example a resin which hardens due to ultraviolet light or an electron beam, i.e., an ionizing radiation curing resin, a resin which is a mixture of an ionizing radiation curing resin with a thermoplastic resin and a solvent, and a thermosetting resin.

The translucent resin may be a polymer having one of a saturated hydrocarbon and a polyether as a main chain, but a polymer having a saturated hydrocarbon as the main chain is more preferred. The translucent resin is preferably cross-linked.

The polymer having a saturated hydrocarbon as a main chain is preferably, for example, a polymer obtained by the polymerization reaction of a monomer having an ethylenic unsaturated group. In order to obtain a cross-linked binder, it is preferred to use a monomer having two or more ethylenic unsaturated groups.

There is no particular limitation on this monomer having two or more ethylenic unsaturated groups which may be suitably selected according to the purpose, examples being esters of a polyhydric alcohol and (meth)acrylic acid, vinylbenzene derivatives, vinyl sulfone, acrylamide and methacrylamide. Among these, from the viewpoint of improving film hardness (scratch resistance), an acrylate monomer or methacrylate monomer having three or more functional groups, and an acrylate monomer having five or more functional groups, are particularly preferred.

A mixture of dipentaerythritol pentaacrylate and dipentaerythritol hexaacrylate is available commercially, and this mixture can also be used.

These may be used alone, or two or more may be used in combination.

The ester of the polyhydric alcohol and (meth)acrylic acid may for example be ethylene glycol di(meth)acrylate, 1,4-cyclohexane diol di(meth)acrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, 1,3,5-cyclohexane triol tri(meth)acrylate, polyurethane poly(meth)acrylate or polyester poly(meth)acrylate. The vinylbenzene derivative may for example be 1,4-divinylbenzene, 4-vinylbenzoic acid-2-acryloyl ethyl ester or 1,4-divinylcyclohexane. The vinylsulfone may for example be divinylsulfone. The acrylamide may for example be methylene bisacrylamide.

The monomer having ethylenic unsaturated groups can be hardened by a polymerization reaction by ionizing radiation or heat, after dissolving with various polymerization initiators and other additive agents in a solvent, coating and drying.

Instead of or in addition to the aforesaid monomer having two or more ethylenic unsaturated groups, a crosslinking structure obtained by reacting a monomer having a crosslinking functional group can also be introduced into the binder.

Examples of this crosslinking functional group monomer are an isocyanate group-containing monomer, an epoxy group-containing monomer, an aziridine group-containing monomer, an oxazoline group-containing monomer, an aldehyde group-containing monomer, a carbonyl group-containing monomer, a hydrazine group-containing monomer, a carboxyl group-containing monomer, a methylol group-containing monomer and an active methylene group-containing monomer. A vinyl sulfonic acid, acid anhydride, cyanoacrylate derivative, melamine, etherated methylol, ester or urethane, a metal alkoxide, such as tetra-methoxy silane, and a compound which contains a functional group exhibiting crosslinking properties as a result of a decomposition reaction such as a block isocyanate group, may also be used. It may also be a monomer or compound containing a crosslinking functional group which, even if it does not immediately show a reaction, does show reactivity as a result of decomposition.

The binder containing these crosslinking functional groups, after application, can form a crosslinking structure by heating.

The refractive index of the translucent resin is preferably 1.51 to 2.00, more preferably 1.51 to 1.90, still more preferably 1.51 to 1.85 and most preferably 1.51 to 1.80.

The refractive index of this translucent resin is a value measured in a state where translucent particles are not included.

If the refractive index is less than 1.51, anti-reflection properties may decrease, and if it exceeds 2.00, the hue of the reflected light may be too strong.

In these translucent particles, by using two or more types of translucent particles having different particle diameters and by mixing these translucent particles, visual angle properties and stray light reflection which are related to display quality can be optimized separately, fine tuning can be performed by adjusting the mixing ratio of translucent particles, better control can be performed than in the case where there is only one type, and various designs can be easily manufactured.

The translucent particles may be mono-dispersed organic particles or may be inorganic particles. The less the scatter in the volume-weighted average particle diameter is, the less scatter in the scattering properties and the easier the design of haze value is.

Examples of organic particles are poly(methylmethacrylate) beads (refractive index 1.49), acrylic-styrene copolymer beads (refractive index 1.54), melamine beads (refractive index 1.57), polycarbonate beads (refractive index 1.57), polystyrene beads (refractive index 1.60), crosslinked polystyrene beads (refractive index 1.61), polyvinyl chloride beads (refractive index 1.60) and benzoguanamine-melamine formaldehyde beads (refractive index 1.68). One of these may be used alone, or two or more may be used in combination.

Examples of inorganic particles are silica beads (refractive index 1.44) and alumina beads (refractive index 1.63). One of these may be used alone, or two or more may be used in combination.

Among these, plastic beads are suitable, in particular those having a high transparency for which the refractive index difference from the translucent resin is the above numerical value.

As mentioned above, the volume-weighted average particle diameter of the translucent particles is preferably within the range of 0.5 to 5 μm. The amount of the translucent particles is preferably 5 to 30 parts by mass relative to 100 parts by mass of the translucent resin.

In the case of the aforesaid translucent particles, translucent particles may tend to sediment in the resin composition (translucent resin), so an inorganic filler such as silica may be added to prevent sedimentation. The larger the addition amount of the inorganic filler is, the greater the effect on preventing sedimentation of translucent particles, but this has an adverse effect on the transparency of the coating film. Therefore, an inorganic filler having an average particle diameter of 0.5 μm or less may be included to the extent that it does not impair the transparency of the coating film, i.e., less than 0.1% by mass relative to the translucent resin.

To acquire a desirable surface scattering, the volume-weighted average particle diameter of the first translucent particles is preferably 2.5 to 5.0 μm, more preferably 2.2 to 4.7 μm and still more preferably 2.4 to 4.5 μm. If it is less than 2.5 μm, surface unevenness decreases, the surface scattering effect is small, and it may not be possible to fully suppress reflection of stray light. If it exceeds 5.0 μm, surface unevenness increases and reflections are suppressed, but there is a marked whitening and the display quality may decline.

To obtain an angular distribution of the light scattering, the volume-weighted average particle diameter of the second translucent particles is preferably 0.5 to 2.0 μm, more preferably 0.6 to 1.8 μm and still more preferably 0.7 to 1.7 μm. If the volume-weighted average particle diameter of the second translucent particles is less than 0.5 μm, there is a large scattering effect and the visual angle property remarkably improves, but back-scattering may increase and the reduction in luminosity may be marked, while if it exceeds 2.0 μm, the scattering effect may decrease and the improvement in the visual angle property may decrease.

The refractive index of the first translucent particles and the second translucent particles is preferably 1.51 to 2.00. The refractive index of the low refractive index layer is preferably 1.35 to 1.45, and the refractive index of the triacetyl cellulose used as the transparent support is 1.48. By increasing the refractive index of the optical diffusion layer in this way, excellent anti-reflection is obtained even when the refractive index of the low refractive index layer is within the range of 1.35 to 1.45.

The differences between the refractive index of the first translucent particles, the second translucent particles and the translucent resin forming the whole light diffusion layer are preferably 0.02 to 0.20, more preferably 0.03 to 0.15, and still more preferably 0.04 to 0.13. If the refractive index difference is less than 0.02, the difference between the two refractive indices is too small and a light scattering effect may not be obtained. If it exceeds 0.20, optical diffusion is too high and the whole film may whiten.

In addition to the translucent resin and translucent particles, the optical diffusion layer preferably contains at least one moiety selected from a monomer having a high refractive index and ultrafine metal oxide particles having a high refractive index.

The aforesaid high refractive index monomer is not particularly limited and may be selected according to the purpose, but examples are bis(4-methacryloyl thiophenyl)sulfide, vinyl naphthalene, vinyl phenyl sulfide and 4-methacryloxyphenyl-4′-methoxy phenyl thioether.

The refractive index of the high refractive index monomer is preferably 1.55 to 2.00, but more preferably 1.60 to 1.75.

The addition amount of the high refractive index monomer is preferably 10 to 90% by mass, but more preferably 20 to 80% by mass, relative to the total mass of translucent resin.

The ultrafine metal oxide particles having a high refractive index are not particularly limited and may be suitably selected according to the purpose, examples being zirconium oxide, titanium oxide, aluminum oxide, indium oxide, zinc oxide, tin oxide and antimony oxide, specifically, ZrO₂, TiO₂, Al₂O₃, In₂O₃, ZnO, SnO₂, Sb₂O₃ and ITO. Among these, ZrO₂ is particularly preferred.

The particle diameter of the ultrafine metal oxide particles is preferably 100 nm or less, but preferably 50 nm or less.

The addition amount of the ultrafine metal oxide particles is preferably 10 to 90% by mass, but more preferably 20 to 80% by mass, relative to the total mass of translucent resin.

If the translucent resin and transparent substrate film are in contact, in order to achieve the dual objectives of anti-glare properties and intimate contact between the support and anti-glare layer, the solvent in the coating solution used to form the translucent resin is preferably prepared from at least one type of solvent which dissolves the transparent substrate film (e.g., the tricaetyl cellulose support), and at least one type of solvent which does not dissolve the transparent film. It is more preferable that at least one type of solvent which does not dissolve the transparent substrate film has a higher boiling point than at least one type of solvent which does dissolve the transparent substrate film. The boiling point difference between the solvent with the highest boiling point among the solvents which do not dissolve the transparent substrate film, and the solvent with the highest boiling point among the solvents which do dissolve the transparent substrate film, is preferably 30° C. or more, but more preferably 50° C. or more.

The solvent which dissolves the transparent substrate film is not particularly limited and may be suitably selected according to the purpose, examples being ethers having 3 to 12 carbon atoms, ketones having 3 to 12 carbon atoms, esters having 3 to 12 carbon atoms and organic solvents having two or more functional groups. Among these, ketone solvents are preferred.

One of these may be used alone, or two or more may be used together.

Examples of ethers having 3 to 12 carbon atoms are dibutyl ether, dimethoxymethane, dimethoxy ethane, diethoxyethane, propylene oxide, 1,4-dioxane, 1,3-dioxolane, 1,3,5-trioxane, tetrahydrofuran, anisole and phenetole. Examples of ketones having 3-12 carbon atoms are acetone, methylethyl ketone, diethyl ketone, dipropyl ketone, diisobutyl ketone, cyclopentanone, cyclohexanone, methylcyclohexanone and methylcyclohexanone. Examples of esters having 3 to 12 carbon atoms are ethyl formate, propyl formate, formic acid n-pentyl, methyl acetate, ethyl acetate, methyl propionate, ethyl propionate, n-pentyl acetate and γ-butyrolactone. Examples of organic solvents having two or more functional groups are 2-methoxymethyl acetate, 2-ethoxymethyl acetate, 2-ethoxyethyl acetate, 2-ethoxyethyl propionate, 2-methoxyethanol, 2-propoxyethanol, 2-butoxyethanol, 1,2-diacetoxyacetone, acetylacetone, diacetone alcohol, methyl acetoacetate and ethyl acetoacetate.

The solvent which does not dissolve the transparent substrate film is not particularly limited and may be suitably selected according to the purpose, examples being methanol, ethanol, 1-propanol, 2-propanol, 1-butanol, 2-butanol, tert-butanol, 1-pentanol, 2-methyl-2-butanol, cyclohexanol, isobutyl acetate, methyl-isobutyl-ketone, 2-octanone, 2-pentanone, 2-hexanone, 2-heptanone, 3-pentanone, 3-heptanone and 4-heptanone.

One of these may be used alone, or two or more may be used together.

The mass ratio of the total amount (A) of solvents which dissolve the transparent substrate to the total amount (B) of solvents which do not dissolve the transparent substrate, is preferably 5/95 to 50/50, more preferably 10/90 to 40/60 and still more preferably 15/85 to 30/70.

The method of hardening the ionizing radiation curing type resin composition may be a method usually used to harden an ionizing radiation curing type resin composition, i.e., electron beam or ultraviolet light irradiation.

In electron beam hardening, an electron beam having an energy of 50 to 1000 keV emitted from various electron beam accelerators, such as a Cockroft-Walton type, a Van Der Graff type, resonance transformation type, insulated core transformer type, linear type, dyanimtron type or high frequency type, is used. The energy of the electron beam is preferably 100 to 300 keV. In the case of ultraviolet curing, the ultraviolet radiation emitted from an optical source such as an ultrahigh pressure mercury lamp, a high pressure mercury-vapor lamp, a low pressure mercury lamp, a carbon arc, a xenon arc or a metal halide lamp can be used.

In the optical diffusion layer, the visual angle property and stray light reflection may be optimized with different means. The aforesaid translucent particles may be used to obtain the desired visual angle property, and surface unevenness for preventing stray light reflection may be produced by an embossing method or the like.

The method of producing surface unevenness may for example be a method for directly imparting unevenness to a film by embossing or sandblasting, a method for coating an ultraviolet curing resin or thermosetting resin on the imperfections of a master wherein surface unevenness has previously been formed by electron beam drawing or laser irradiation, followed by curing and peeling, or a method for mechanically transferring imperfections by embossing or the like.

The surface roughness (Ra) which is a measure of the surface unevenness of the optical diffusion layer is preferably 1.2 μm or less, more preferably 0.8 μm or less and still more preferably 0.5 μm or less.

Herein, surface roughness (Ra) can be measured using an atomic force microscope (AFM), for example.

This atomic force microscope is not particularly limited and can be suitably selected according to the purpose, for example, SPI 3800N (SEIKO Instruments Inc.).

The thickness of the optical diffusion layer is preferably 0.5 to 50 μm, more preferably 1 to 20 μm, still more preferably 2 to 10 μm and most preferably 3 to 5 μm. In order to confer anti-glare properties, it is important to control surface unevenness within the above-mentioned range, and the thickness of the optical diffusion layer is preferably 75% or more, but less than 100%, relative to the translucent particles.

Low Refractive Index Layer

The low refractive index layer is provided on the uppermost layer on the side of the support with the optical diffusion layer for the purpose of conferring anti-reflection properties, and the refractive index of this low refractive index layer is 1.35 to 1.45, as mentioned above.

The refractive index of the low refractive index layer preferably satisfies the following Relation 1:
(mλ/4)×0.7<n₁d₁<(mλ/4)×1.3 <Relation 1>
where, in Relation 1, m is a positive odd number (generally 1), n₁ is the refractive index of the low refractive index layer, d₁ is the thickness (nm) of the low refractive index layer, and λ is the wavelength of visible radiation and is a value in the range 450 to 650 (nm).

Satisfying Relation 1 means that there is a value of m (positive odd number-usually 1) which satisfies Relation 1 in the aforesaid wavelength range.

The low refractive index layer can be formed by a method wherein a transparent metal oxide thin film is chemically vapor-deposited (CVD method) or physically vapor-deposited (PVD method), in particular, the vacuum deposition method which is a particular kind of physical vapor deposition, and coating of inorganic particles or polymers and monomers. The forming method is not discussed in the present invention, but a coating method which is economical and permits mass production is preferred.

For the low refractive index layer, a fluorinated resin wherein a thermosetting or ionizing radiation-hardening type crosslinking fluorinated compound has been hardened, is preferred. In this case, it has excellent scratch resistance compared to the low refractive index layer containing magnesium fluoride and calcium fluoride, even if it is used as the uppermost layer. The refractive index of the thermosetting or ionizing radiation-hardening type crosslinking fluorinated compound is preferably 1.35 to 1.45. The dynamic frictional coefficient of the hardened fluorinated resin is preferably 0.03 to 0.15, and the contact angle with water is preferably 90 to 120°.

The crosslinking fluorinated compound, in addition to a perfluoroalkyl group-containing silane compound (e.g., (heptadecafluoro-1,1,2,2-tetrahydrodecyl)triethoxysilane), may be a fluorinated copolymer having a fluorinated monomer and a monomer for conferring a crosslinking group as a structural unit.

Examples of the fluorinated monomeric unit are fluoroolefins, partially or fully fluorinated alkylester derivatives of (meth)acrylic acid, and fully or partially fluorinated vinyl ethers.

Examples of fluoroolefins are fluoroethylene, vinylidene fluoride, tetrafluoroethylene, hexafluoropropylene and perfluoro-2,2-dimethyl-1,3-dioxole. The partially or fully fluorinated alkylester derivative of (meth)acrylic acid may for example be Biscoat 6FM (Osaka Organic Chemical Industries, Ltd.), or M-2020 (Daikin Industries, Ltd.).

Examples of monomers used to confer the crosslinking group are (meth)acrylate monomers having a crosslinking functional group in the molecule such as glycydyl methacrylate, and (meth)acylate monomers having a carboxyl, hydroxyl, amino or sulfonic acid group in the molecule (e.g., (meth)acrylic acid, methylol(meth)acrylate, hydroxyalkyl(meth)acrylate and allyl acrylate). In JP-A No. 10-25388 and JP-A No. 10-147739, it is disclosed that after performing copolymerization of the monomer for conferring the aforesaid crosslinking group, the crosslinking structure can be introduced.

As the aforesaid low refractive index layer, not only the copolymer of the fluorinated monomer and the monomer for conferring a crosslinking group, but also a polymer in which other monomers have been copolymerized therewith, may be used.

The other monomer is not particularly limited and can be suitably selected according to the purpose, examples being olefins, acrylic esters, methacrylic esters, styrene derivatives, vinyl ethers, vinyl esters, acrylamides, methacrylamides and acrylonitrile derivatives. One or more of these may be used alone, or two or more may be used in combination.

Examples of olefins are ethylene, propylene, isoprene, vinyl chloride and vinylidene chloride. Examples of acrylic esters are methyl acrylate, ethyl acrylate and 2-ethylhexyl acrylate. Examples of methacrylic esters are methyl methacrylate, ethyl methacrylate, butyl methacrylate and ethylene glycol dimethacrylate. Examples of styrene derivatives are styrene, divinylbenzene, vinyltoluene and alpha-methyl styrene. An example of vinyl ethers is methylvinyl ether. Examples of vinyl esters are vinyl acetate, vinyl propionate and vinyl cinnamate. Examples of acrylamides are N-tert-butylacrylamide and N-cyclohexyl acrylamide.

In order to give scratch-proofness to the fluorinated resin used for the low refractive index layer, it is preferred to add ultrafine silica particles. The average particle diameter of these ultrafine silica particles is preferably 0.1 μm or less, but more preferably 0.001 to 0.05 μm. From the viewpoint of anti-reflection properties, the refractive index is preferably low, but when the refractive index of the fluorinated resin is lowered, the scratch-proofness becomes poorer. Therefore, an optimum balance point between scratch-proofness and low refractive index can be found by optimizing the refractive index of the fluorinated resin, and the addition amount of ultrafine Si oxide particles.

The ultrafine Si oxide particles may be obtained by adding a silica sol dispersed in a commercial organic solvent as it is, or by dispersing a commercial silica powder in an organic solvent.

For the low refractive index layer, the charge as determined by peeling off the sample in a direction perpendicular to the substrate plane, measured at normal temperature and normal humidity for one of triacetyl cellulose (TAC) and polyethylene terephthalate (PET), is preferably −200 to +200 pc (picocoulombs)/cm², more preferably −100 to +100 pc/cm², still more preferably −50 to +50 pc/cm² and most preferably 0 pc/cm². The charge as determined by peeling off the sample in a direction perpendicular to the substrate plane, measured at normal temperature and 10% RH, is preferably −100 to +100 pc/cm², more preferably −50 to +50 pc/cm² and most preferably 0 pc/cm².

Herein, a pc (picocoulomb) which is the unit of charge as determined by peeling off the sample in a direction perpendicular to the substrate plane, is 10-12 Coulombs.

Herein, as a method of measuring the charge as determined by peeling off the sample in a direction perpendicular to the substrate plane, the measurement sample is for example left at the measurement temperature and humidity for 2 hours or more. The measurement device comprises a stand on which the measurement sample is placed, a head which holds a partner film and repeatedly sticks it to and peels it off the measurement sample, and an electrometer which measures charge amount connected to this head. Next, the film to be measured is placed on the stand, and TAC or PET is fitted to the head. After discharging the measurement part, the head is repeatedly pressed against and separated from the measurement sample, the charge value in the first peeling and the fifth peeling is read, and these are averaged. This is repeated for three samples, and the average of all of these is taken as the charge as determined by peeling off the sample in a direction perpendicular to the substrate plane.

Depending on the kind of partner film or measurement sample, a positive charge or a negative charge may develop, but only the magnitude of the absolute value is important.

In general, the absolute charge value increases in a low humidity environment. In the case of the anti-glare, anti-reflection film of the present invention, this absolute value is also small.

As the absolute value of the charge as determined by peeling off the sample in a direction perpendicular to the substrate plane at normal temperature, normal humidity, and at normal temperature, 10% RH, is small, this low refractive index layer also has excellent anti-dust properties.

In order to make the value of the charge as determined by peeling off the sample in a direction perpendicular to the substrate plane lie within the above-mentioned range, the proportion of various elements on the surface of the low refractive index layer is adjusted.

The surface resistance value of the low refractive index layer is preferably 1×10¹¹ Ω/□ (sq.) or more, but more preferably 1×10¹² Ω/□ (sq.).

Herein, the surface resistance value can be measured for example by the circular electrode method disclosed by JIS C-2141. Specifically, a voltage is applied, the current value after 1 minute is read, and the surface resistance value (SR) is then calculated.

In the present invention, the concept is fundamentally different from the method of improving anti-dust properties (anti-soiling properties) by making the surface resistance value small, for example, 1×10¹⁰ Ω/□ (sq.) or less. As this method causes the image display quality to fall, it is not used here. Instead, in the present invention, the absolute value of the charge as determined by peeling off the sample in a direction perpendicular to the substrate plane is made small by the above method, so it is not necessary to reduce the surface resistance value, the surface resistance value can be made equal to 1×10¹¹ Ω/□ (sq.) or more, and the image display quality does not fall.

In this low refractive index layer, the average value of the mirror reflectivity at 5° incidence in a wavelength range of 450 nm to 650 nm is preferably 2.5% or less, more preferably 1.2% or less, and still more preferably 1.1% or less. The average value of the integrated reflectivity at 5° incidence in a wavelength range of 450 nm to 650 nm is preferably 2.5% or less, and more preferably 2.3% or less.

Herein, the mirror reflectivity at 5° incidence is the ratio of the light intensity reflected in the normal direction of the sample−5°, relative to the light intensity incident in the normal direction of the sample+5°, and is a measure of the light reflected due to specular reflection of the background. If this is applied to an anti-glare, anti-reflection film, the light intensity of light reflected in the normal direction−5° becomes weaker by the amount of the scattered light due to surface unevenness provided to confer anti-glare properties. Therefore, mirror reflectivity can be described as a measurement method which takes account of the contribution of both anti-glare properties and anti-reflection properties.

On the other hand, the integrated reflectance at 5° incidence is the ratio of the integral value of optical intensity reflected in all directions, relative to the light intensity incident in the normal direction of the sample+5°. If this is applied to an anti-reflection film, there is no reduction of the reflected light due to anti-glare properties, so a measurement which takes account of only anti-reflection properties can be performed.

Therefore, both anti-glare properties and anti-reflection properties can be simultaneously satisfied by making the average values in the wavelength region from 450 nm to 650 nm, 2.5% or less (mirror reflectivity) and 2.5% or less (integration reflectance).

If the average value of the mirror reflectivity of the low refractive index layer at 5° incidence in the wavelength region from 450 nm to 650 nm exceeds 2.5%, reflection of the background may become problematic, and the visibility when applied to the surface film of the display may fall.

On the other hand, if the average value of the integration reflectance of the low refractive index layer at 5° incidence in the wavelength region from 450 nm to 650 nm exceeds 2.5%, the effect of improving contrast of the display may decrease, the display screen may whiten due to scattered light resulting from the surface unevenness which confers anti-glare properties, and the display quality of the display may fall.

In the low refractive index layer, if the hue of the regular reflection light relative to the light incident at 5° from a CIE standard light source D65 is quantified by the values L*, a*, and b* of the CIE1976 L*a*b* color space, the design is preferably such that these values are respectively within the limits of L*≦10, 0≦a*≦2, and −5≦b*≦2. The regular reflection light which satisfies these relations is a neutral hue.

The hue of the regular reflection light relative to the light incident at 5° from the CIE standard light source D65 can be quantified by respectively computing the L*, a* and b* values of the CIE1976 L*a*b* color space, from the measured values of the mirror reflectivity within a wavelength region of 380 nm to 780 nm at 5° incidence, and the spectral reflection spectrum obtained by computing the integral of the spectral distribution at each wavelength of the light source D65.

If the L* value exceeds 10, anti-reflection properties may not be sufficient. If the a* value exceeds 2, the reddish purple of the reflected light may become more intense, and if it is less than zero, green becomes more intense which is undesirable. If the b* value is less than −5, blue may become more intense, and if it exceeds 2, yellow becomes more intense which is undesirable.

The anti-reflection film which has a neutral hue reflection, and has a low reflectance, is obtained by optimizing the balance between the refractive index of the low refractive index layer, and the refractive index of the translucent resin material of the optical diffusion layer.

In general, in a low refractive index layer comprising an optical thin film formed by the vapor deposition or sputtering of three or more layers, although it was possible to decrease the average value of mirror reflectivity to 0.3% or less, and therefore to reduce the L* value to 3 or less, the a* value was 10 or more and the b* value was a value less than −10, so the hue of the reflected light was extremely intense. However, in the anti-reflection film comprising the aforesaid optical diffusion layer, the hue of the reflected light is largely improved.

Herein, a specific example of the optical diffusion film of the present invention will be described referring to the drawings.

The optical diffusion film shown in FIG. 2 comprises a transparent substrate film 20 and an optical diffusion layer 30 which contains two or more kinds of translucent particles (for example, a first translucent particle 41 and a second translucent particle 42) for which at least one of the refractive index and particle diameter are mutually different, in a translucent resin 31. A low refractive index layer 50 may also be laminated on this optical diffusion layer 30 if required. The optical diffusion layer 30 may be formed from two or more layers. Herein, two types of translucent particles having two different refractive index each other will be described, but two or more types of translucent particles may also be used, and in order to satisfy the object and effect of the present invention, particles having two or more particle diameters are preferred.

<Polarizing Plate>

The polarizing plate is not particularly limited and may be suitably selected according to the purpose, but it also has a polarizing film and two protective films disposed on both sides of this polarizing film and may comprise other layers if required.

One of the aforesaid two protective films may for example be an optical diffusion film according to the present invention, or an optically anisotropic layer comprising a liquid crystal compound. The other protective film may be an ordinary cellulose acetate film.

The polarizing film may be an iodine polarizing film, a dye polarizing film using dichroic dyes, or a polyene polarizing film. The iodine polarizing film and dye polarizing film are generally manufactured using a polyvinyl alcohol film.

In order to increase the productivity of the polarizing plate, the moisture permeability of the protective film is an important factor.

The polarizing film and protective film are stuck together with a water-based adhesive, and this adhesive solvent is dried by spreading it through the protective film. The higher the moisture permeability of the protective film is, the faster it dries and productivity therefore improves, but if it becomes too high, its polarizing ability will fall due to the entry of moisture into the film under the service conditions (high humidity) of the liquid crystal display.

The moisture permeability of the polarizing plate is determined by the thickness of the transparent substrate and polymer film (and polymerizing liquid crystal compound), the free volume, and hydrophilic/hydrophobic properties.

When the optical diffusion film and low refractive index layer are used as a protective film of a polarizing plate, the moisture permeability is preferably 100 to 1000 g/m²/24 hrs, but more preferably 300 to 700 g/m²/24 hrs. In film production, the thickness of the transparent substrate can be adjusted by the lip flux, line speed, or extension and compression. The moisture permeability varies according to the main materials used, and it can be adjusted within a desirable range by adjusting the thickness.

In film production, the free volume of the transparent substrate can be adjusted by the drying temperature and time. In this case, the moisture permeability varies according to the main materials used, and it can be adjusted within a desirable range by adjusting the free volume.

The hydrophilic/hydrophobic properties of the transparent substrate can be adjusted by additives. The moisture permeability increases by adding a hydrophilic additive to the free volume, and conversely, the moisture permeability can be reduced by adding a hydrophobic additive.

By controlling the moisture permeability independently, a polarizing plate which has optical compensation ability can be manufactured economically with high productivity.

In the present invention, it is preferred that the polarizing plate has an optically anisotropic layer further comprising a liquid crystal compound from the viewpoint that the gray scale inversion angle of the liquid crystal cell can be extended to a wide angle.

Optically Anisotropic Layer Comprising Liquid Crystal Compound

There is no particular limitation on the liquid crystal compound which can be suitably selected according to the purpose, and they may be rod-shaped liquid crystals or discotic liquid crystals. These further include high polymer liquid crystals or low polymer liquid crystals, and liquid crystal compounds crosslinked by low polymer liquid crystals which no longer show liquid crystal properties. Among these, discotic liquid crystals are particularly preferred.

Examples of rod-shaped liquid crystals are described, for example, in JP-A No. 2000-304932.

Examples of discotic liquid crystals are for example the benzene derivatives described in the research reports of C. Destrade et al, Mol. Cryst. Vol.71, p.111 (1981); the toluene derivatives described in the research reports of C. Destrade et al, Mol. Cryst. Vol. 122, p.141 (1985), Physics lett, A, Vol. 78, p.82 (1990); the cyclohexane derivatives described in research reports of B. Kohne et al, Angew. Chem. Vol. 96, p. 70 (1984); and the aza-crown or phenylacetylene macroscopic derivatives described in the research reports of J. M. Lehn et al, J. Chem. Commun., p. 1794 pages (1985), and the research reports of J. Zhang et al, J. Am. Chem. Soc. Vol. 116, p. 2655 (1994).

The discotic liquid crystals generally have these derivatives as nuclei at the center of the molecule, with straight-chain alkyl groups or alkoxy groups, or substituted benzoyl oxy-groups as straight chains having radial substitutions, and they exhibit liquid crystallinity. They are not particularly limited provided that the molecules have an axis symmetry and a fixed orientation can be given to them, but compounds formed from disk-like compounds are preferred.

In the case of these compounds formed from disk-like compounds, it is unnecessary that the final product is a disk-like compound. For example, low molecular weight discotic liquid crystals also include compounds having a group which reacts due to heat or light, and as a result, polymerizes or cross-links due to a heat or light-induced reaction so that they polymerize and liquid crystal properties are lost. Suitable examples of these discotic liquid crystals are given in JP-A No. 8-50206.

The optically anisotropic layer is a layer comprising a compound with a discotic structural unit, and preferably, the inclination of the surface of this discotic structural unit to the transparent support surface, and the angle made by this discotic structural unit with the transparent support surface, vary in the depth direction of the optically anisotropic layer.

In general, the angle (inclination angle) of the surface of the discotic structural unit is the depth direction of the optically anisotropic layer, and increases or decreases with the increase in distance from the base surface of the optically anisotropic layer. The inclination angle preferably increases with increase in distance. Further, inclination angle variations include continuous increases, continuous decreases, intermittent increases, intermittent decreases, variations including continuous increases and continuous decreases, and intermittent variations including increases and decreases. Intermittent variations include regions where the inclination angle does not vary midway in the thickness direction.

Even if the inclination angle includes a range of non-variance, it is preferred that there is an overall increase or decrease. It is moreover preferred that there is an overall increase, and particularly preferred that there is a continuous variation.

The optically anisotropic layer is generally obtained as follows. The solution wherein a discotic compound and other compounds have been dissolved in a solvent on an orienting film, is coated on an orienting film, and dried. Next, it is heated to a discotic nematic phase-forming temperature, and cooled while maintaining the orientation state (discotic nematic phase). For the aforesaid optically anisotropic layer, a solution containing a discotic compound or another compound (e.g., a polymerization monomer or photopolymerization initiator) dissolved in a solvent is coated on an orienting film, and dried. Next, it is heated to the discotic nematic phase-forming temperature, and polymerized (by irradiation of UV light, etc.). It is then obtained by cooling. The discotic nematic liquid crystal phase-solid phase transition temperature of the discotic liquid crystal compound is preferably 70 to 300° C., but more preferably 70 to 170° C.

For example, the inclination angle of the discotic unit on the support side can generally be adjusted by selecting the material of the discotic compound or orientating film, or by selecting the rubbing treatment method. Further, the inclination angle of the discotic unit on the surface side (air side) can generally be adjusted by selecting the discotic compound or another compound (e.g., a plasticizer, a surfactant, a polymerizing monomer or polymer) used together with the discotic compound.

The extent of variation of the inclination angle can also be adjusted by an identical selection.

Preferred examples of the orienting film, plasticizer, surfactant and polymerizing monomer are given in JP-A No. 2002-328228 and JP-A No. 09-152509.

The transparent support on which the optically anisotropic layer comprising the liquid crystal compound is coated, is not particularly limited provided that it is a high transmissivity plastic film, and can be suitably selected according to the purpose, but for example cellulose acetate which is the protective film of the polarizing plate is preferably used. The transparent support may also be optically mono-axial or biaxial.

The transparent support on which the optically anisotropic layer is coated, itself play an important role optically. The Re retardation value, is preferably 0 to 200 nm, but more preferably, its Rth retardation value is 70 to 400 nm.

In the liquid crystal display, if two optical anisotropy cellulose acetate films are used, the Rth retardation value of these films is preferably 70 to 250 nm.

In the liquid crystal display, if one optical anisotropy cellulose acetate film is used, the Rth retardation value of the film is preferably 150 to 400 nm.

The birefringence (Δn:nx−ny) of the cellulose acetate film is preferably 0.00 to 0.002. The birefringence {(nx+ny)/2−nz} in the thickness direction of the cellulose acetate film is preferably 0.001 to 0.04.

The aforesaid retardation value (Re) can be computed by the following Equation 2:
Retardation value(Re)=(nx−ny)xd <Equation 2>

In Equation 2, nx is the refractive index in the retardation phase axis direction in the plane of a phase difference plate (maximum refractive index in the plane). ny is the refractive index in a perpendicular direction to the retardation phase axis in the plane of a phase difference plate.

The retardation value (Rth) can be computed by the following Equation 3.
Rth={(nx+ny)/2−nz}×d <Equation 3>

In Equation 3, nx is the refractive index in the retardation phase axis direction (direction in which the refractive index is a maximum) in the film plane. ny is the refractive index in the advance phase axis direction (direction in which the refractive index is a minimum) in the film plane. nz is the refractive index in the film thickness direction. d is the film thickness having nm as units.

<Liquid Crystal Cell>

The liquid crystal cell is preferably supported between two substrates. It may be used for example in a VA mode, TN mode, OCB mode and ECB mode, but preferably in the TN mode, OCB mode and ECB mode.

The liquid crystal cell in the OCB mode is a liquid crystal display using a liquid crystal cell in a bend orientation mode, wherein rod-shaped liquid crystal molecules are (symmetrically) oriented effectively in the reverse direction to the upper part and lower part of the liquid crystal cell, and is disclosed by U.S. Pat. No. 4,583,825 and U.S. Pat. No. 5,410,422. As the rod-shaped liquid crystal molecules are symmetrically oriented between the upper part and lower part of the liquid crystal cell, a liquid crystal cell in the bend orientation mode has a self-optical compensation function. Therefore, this liquid crystal mode is also called an OCB (Optically Compensatory Bend) liquid crystal mode.

The advantage of a liquid crystal display in the bend orientation mode is fast response speed.

In a liquid crystal cell in the TN mode, when a voltage is not applied, the rod-shaped liquid crystal molecules are effectively horizontally oriented, and are also skewed by 60 to 120°. Liquid crystal cells in the TN mode are most often used as color TFT liquid crystal displays, and are frequently mentioned in the literature.

In a liquid crystal cell in the ECB mode, when a voltage is not applied, the rod-shaped liquid crystal molecules are effectively horizontally oriented. The ECB mode is one of the liquid crystal display modes having the simplest structure, and is frequently mentioned in the literature.

<Backlight>

The backlight is an external irradiation light source in a liquid crystal display, and it may use (i) a cold cathode tube (fluorescent) lamp, (ii) a light emitting diode (LED), or (iii) EL (electroluminescence). Among these, backlights using the (i) the cold cathode tube (fluorescent) lamp are the mainstream.

Backlights using the cold cathode tube (fluorescent) lamp may for example be a directly underneath type, a sidelight type or a planar light source type. From the viewpoints of thinness and lightweightness of the LCD panel, the sidelight type is preferred.

Herein, a specific example of the backlight of the present invention will be described referring to the drawings.

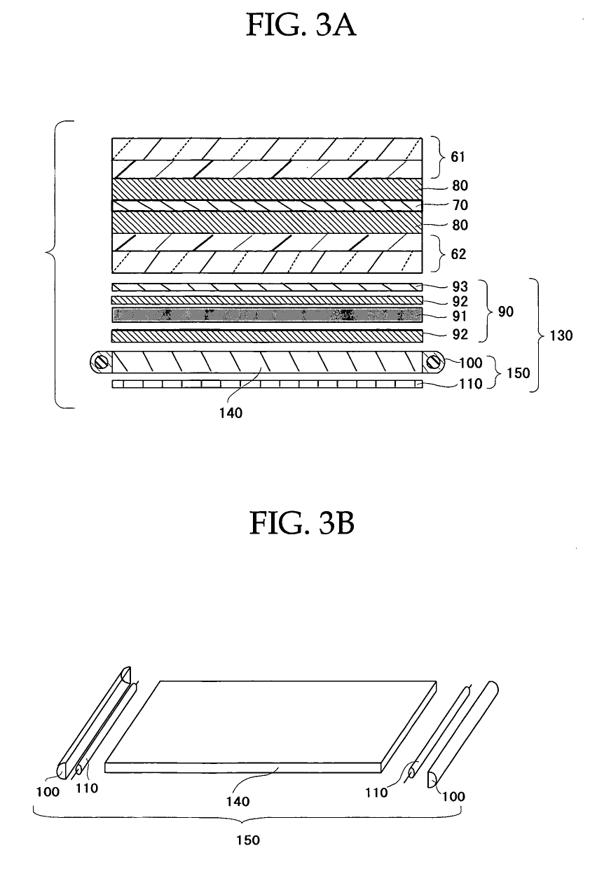

FIG. 3A shows a cross-sectional view of the structure of a liquid crystal display drawn in concept form, and FIG. 3B shows a perspective view of a light source unit with which the liquid crystal display is provided.

The liquid crystal display is provided with a liquid crystal display element (liquid crystal display panel) comprising a pair of substrates 80 disposed so that their principal surfaces are facing each other and a liquid crystal layer 70 sandwiched therebetween, and a light source unit 150 on which a fluorescent lamp 110 is mounted. Polarizing plates 61, 62 are installed on the principal surfaces of the substrates 80 respectively forming the liquid crystal display element, on the opposite side to the liquid crystal layer 70, and plural pixels (not shown) are disposed in two dimensions on the principal surface of at least one of the pair of substrates 80 on the side of the liquid crystal layer 70. The user of the liquid crystal display views an image displayed as an optical transmittance pattern of the liquid crystal layer via the principal surface of the substrate 80 from the upper part of FIG. 3A.

FIG. 3B shows what is referred to as the sidelight type (or edge light type) due to the arrangement of the fluorescent lamp 110 in the light source unit 150. This light source unit 150 comprises a light guide plate 140 having a rectangular upper surface disposed facing the lower surface of the liquid crystal display element, the tubular fluorescent lamp 110 disposed along at least one of the lateral surfaces (sides of the rectangle) of the light guide plate, a lamp reflector 100 which guides light radiated from this fluorescent lamp 110 to the opposite side of the light guide plate, to be incident on the lateral surface of the light guide plate, and a reflecting film (not shown) which reflects light propagated through the light guide plate towards its lower surface, towards its upper surface and irradiates the lower surface of the liquid crystal display element.

An optical sheet assembly 90 comprising for example a pair of diffusion sheets 92, a prism sheet 91 sandwiched therebetween and a luminosity enhancing film 93, is disposed between the upper surface of the light guide plate 140 and the lower surface of the liquid crystal display element. It should be noted that, in this sidelight liquid crystal display, the lower surface of the liquid crystal display element is not facing the fluorescent lamp 110, but is disposed facing the upper surface of the light guide plate 140 shown in FIG. 3B.

In the present invention, the unit 130 comprising the various optical sheets 90 are referred to collectively as a backlight unit.

In the transmitting type liquid crystal display of the present invention, the anisotropic scattering film is disposed between the backlight and the liquid crystal cell, and by selectively scattering light at an angle for which gray scale inversion of the liquid crystal cell occurs, incident light at an angle for which gray scale inversion occurs is relatively suppressed. Further, by scattering light for which gray scale inversion does not occur by the optical diffusion film on the visual recognition side of the liquid crystal cell, gray scale inversion can be largely improved, visual field angle dependency is largely improved, reflection of stray light is prevented, and front contrast and image clarity are enhanced.

Hereafter, the present invention will be described referring to specific embodiments, but it should be understood that the invention is not be construed as being limited to these embodiments.

Measurement of Gray Scale Inversion Angle of Liquid Crystal Cell

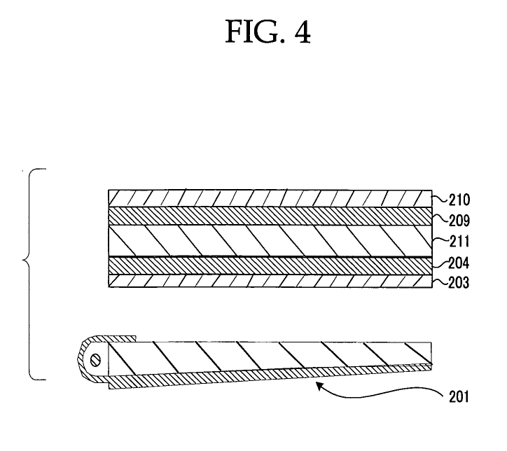

A pair of polarizing plates provided in a liquid crystal display (TH-14TA3, Matsushita Electric Industrial Co., Ltd.) which uses the TN type liquid crystal cell shown in FIG. 4 were removed, and a LPT-HL56 (Sanritz Corporation) polarizing plate, a commercial polarizing plate with an optical compensation sheet, was stuck on instead. The transmission axis of the polarizing plate on the observer side and the transmission axis of the polarizing plate on the backlight side were arranged to give the O mode.

In FIG. 4, 201 is a backlight unit, 203 is a polarizing film, 204 is an optically anisotropic layer, 209 is an optically anisotropic layer, 210 is a polarizing film, and 211 is a liquid crystal cell, respectively.

Next, the luminosity of the liquid crystal display modified from the liquid crystal display of FIG. 4, was measured in eight levels from black (L0) to white (L7) using a measurement device (EZ-Contrast 160D, ELDIM). L1 to L6 are gray shades of light and dark produced by dividing the luminosity of black and white into substantially equal intervals.

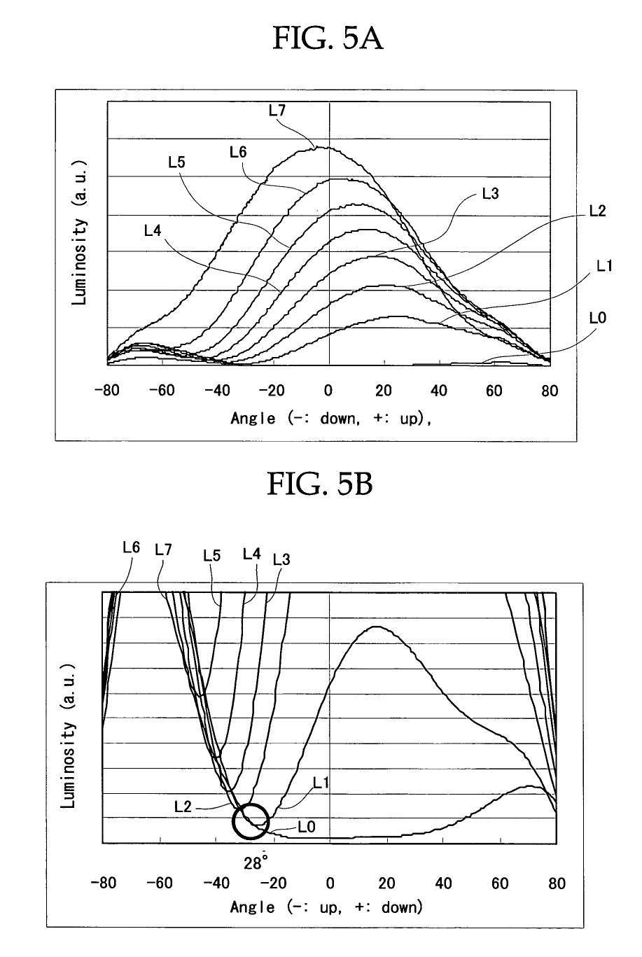

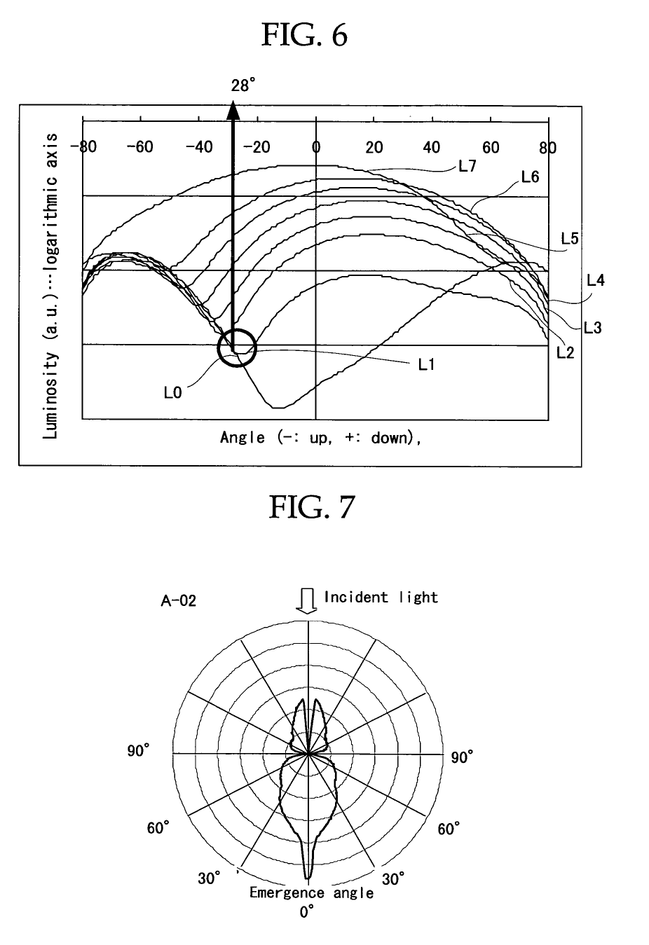

The luminosity results in the up/down direction (the up direction is indicated by “+”, and the down direction is indicated by are shown in FIG. 5A, FIG. 5B, and FIG. 6.

From the results of FIG. 5A, FIG. 5B, and FIG. 6., it is seen that in the aforesaid liquid crystal device, a gray scale inversion phenomenon occurs in the down direction of the liquid crystal panel, and that the gray scale inversion angle is approx. 30° (28°).

The gray scale inversion angle means the first angle at which the luminosity order between different voltages is replaced when a voltage is applied to the liquid crystal cell.

Properties of Anisotropic Scattering Film

The anisotropic scattering film having different scattering properties (scattering efficiency) depending on the incident light was “MFZ-2555” (LUMISTY, Sumitomo Chemical Co., Ltd.). The haze of this anisotropic scattering film relative to the incident angle is shown in Table 1. This anisotropic scattering film has the anisotropy that light incident from the normal direction is transmitted, and the scattering property changes with the azimuthal angle for an incidence with a polar angle of 20° or more.

In the present invention, the anisotropic scattering film is disposed between the backlight and the liquid crystal cell so that the direction in which the haze increases at a polar angle of 20° or more, is the up/down direction.

TABLE 1

| Angle (°) | Haze (%) | Angle (°) | Haze (%) |
|---|---|---|---|
| Bottom 60 | 86 | Left 60 | 34 |
| Bottom 50 | 94 | Left 50 | 31 |
| Bottom 40 | 94 | Left 40 | 26 |
| Bottom 30 | 84 | Left 30 | 24 |
| Bottom 20 | 62 | Left 20 | 23 |
| Bottom 10 | 24 | Left 10 | 22 |
| 0 | 22 | 0 | 22 |
| Top 10 | 24 | Right 10 | 22 |
| Top 20 | 50 | Right 20 | 23 |
| Top 30 | 88 | Right 30 | 25 |
| Top 40 | 93 | Right 40 | 28 |
| Top 50 | 93 | Right 50 | 34 |
| Top 60 | 86 | Right 60 | 44 |

From the results of Table 1, it is seen that the difference between the haze at an angle (bottom) of 30° at which gray scale inversion of the liquid crystal cell occurs, and the haze at 0° incidence, is 60% or more. In this example, “MFZ-2555” (LUMISTY, Sumitomo Chemical Co., Ltd.) was used as the anisotropic scattering film having different scattering properties at a polar angle of 20° or more, but the invention is not limited thereto, and for example, if the anisotropic scattering film has different scattering properties at a polar angle of 350, the visual angle improvement effect appears to be larger if this anisotropic scattering film is used.

Manufacture of Optical Diffusion Film (A-01)

A coating solution for an optical diffusion layer was manufactured by mixing 100 mass parts of an ultrafine silica particle dispersion-containing hard coat solution (DESOLITE Z7526, JSR Corporation, refractive-index 1.51) as an optically transmitting resin forming the optical diffusion layer, 25 parts by mass of a crosslinked polystyrene resin (Soken Chemical & Engineering Co., Ltd., SX130H, volume-weighted average particle diameter 1.3 μm, refractive-index 1.61) as optically transmitting particles and 6 25 parts by mass of crosslinked polystyrene beads (Soken Chemical & Engineering Co., Ltd., SX350H, volume-weighted average particle diameter 3.5 μm, refractive-index 1.61) as optically transmitting particles, so that the solid concentration was 45% by mass using methylethylketone/methylisobutylketone=20/80 (mass ratio) as solvent.

Next, the coating solution for an optical diffusion layer thus obtained was coated on a triacetyl cellulose film (Fuji Photo Film Co. Ltd., TD 80U) so that the coating amount of the crosslinked polystyrene beads having an volume-weighted average particle diameter of 1.3 μm was 1.1 g/m², the solvent was dried, and irradiation with ultraviolet light at an illumination of 400 mW/cm² and dose of 300 mJ/cm² was performed using a 160 W/cm air-cooled metal halide lamp (EYEGRAPICS CO., LTD.) so as to cause hardening and form the optical diffusion layer.

In this way, the optical diffusion film (A-01) was prepared.

Manufacture of Optical Diffusion Film (B-01)

An optical diffusion film (B-01) was manufactured in the same way as for the optical diffusion film (A-01), except that in the method for manufacturing the aforesaid optical diffusion film (A-01), the coating amount of crosslinked polystyrene beads having an volume-weighted average particle diameter of 1.3 μm, was changed from 1.1 g/m² to 0.2 g/m².

Preparation of Low Refractive Index Layer Coating Solution

93 g of a heat-crosslinking fluorinated polymer (JN7228A, JSR Corporation) having a refractive index of 1.42, 8 g of MEK-ST (methylethylketone (MEK) dispersion of SiO₂ sol containing 30% by mass solids having an average particle diameter of 10 to 20 nm, Nissan Chemical Industries Ltd.) and 100 g methylethylketone (MEK) were mixed, stirred, and filtered on a polypropylene filter having a pore size of 1 micrometer. In this way, a coating solution for a low refractive index layer was prepared.

Manufacture of Optical Diffusion Film (A-02) with Low Refractive Index Layer

The low refractive index layer coating solution was coated on the optical diffusion layer in the aforesaid optical diffusion film (A-01) using a bar coater, dried at 80° C., and heat crosslinked at 120° C. for 10 minutes to form a low refractive index layer having a thickness of 0.096 μm. In this way, the optical diffusion film (A-02) with a low refractive index layer was manufactured.

Manufacture of Optical Diffusion Film (B-02) with Low Refractive Index Layer

The low refractive index layer coating solution was coated on the optical diffusion layer in the aforesaid optical diffusion film (B-01) using a bar coater, dried at 80° C., and heat crosslinked at 120° C. for 10 minutes to form a low refractive index layer having a thickness of 0.096 μm. In this way, the optical diffusion film (B-02) with a low refractive index layer was manufactured.

Evaluation of Optical Diffusion Films

The haze and scattered light profile of the optical diffusion film (A-01), and optical diffusion films (A-02) and (B-02) with low refractive index layer thus obtained, were evaluated as follows. The results are shown in Table 2.

<Measurement of Haze>

The haze H(0) was measured for each optical diffusion film was measured using a haze meter MODEL 1001DP (Nippon Denshoku Industries Co., Ltd.). The results are shown in Table 2.

<Evaluation of Scattered Light Profile>

For each optical diffusion film, using an automatic angle variation photometer GP-5 (Murakami Color Research Laboratory), the optical diffusion film was disposed perpendicularly relative to the incident light, and the scattered light profile was measured through all azimuths. The ratio of the scattered light intensity at 30° relative to the light intensity at an emission angle of 0°, and the ratio of the scattered light intensity at 60° relative to the light intensity at an emission angle of 0°, were calculated. The results are shown in Table 2. The scattering profile for the optical diffusion film (A-02) is also shown in FIG. 7.

TABLE 2

| Optical | Total | Internal | Scattered light | Scattered light |
|---|---|---|---|---|
| diffusion | haze | haze | intensity ratio | intensity ratio |
| film | (%) | (%) | (30°/0°) | (60°/0°) |
| A-01 | 54 | 43 | 0.08 | 0.0055 |
| A-02 | 53 | 41 | 0.08 | 0.005 |
| B-02 | 28 | 15 | 0.005 | 0.0003 |

From the results of Table 2, it is seen that for the optical diffusion films (A-01) and (A-02), as compared with the optical diffusion film (B-02), the scattered light intensity at 30° relative to the light intensity at an emission angle of 0°, the haze H(0), and the scattered light intensity at 60° relative to the light intensity at an emission angle of 0°, are all higher.

Next, a polarizing plate was manufactured using the optical diffusion film, and an evaluation was performed with a liquid crystal display.

Manufacture of Visual Recognition Side Polarizing Plates (PA-01), (PA-02) and (PB-02)

First, a polarizing film was manufactured by adsorbing iodine on an extended polyvinyl alcohol film. A saponification treatment was given to the optical diffusion films (A-01), (A-02) and (B-02), and these were then stuck to one side of this polarizing film so that the transparent substrate (triacetyl cellulose film) of the optical diffusion film was on the polarizing film side, using a 3% by mass aqueous solution of PVA (Kuraray Co., Ltd., PVA-117H) as adhesive. At the same time, saponification treatment was given to an optical compensation film WV A 12B (Fuji Photo Film Co., Ltd.) comprising an optically anisotropic layer of a discotic liquid crystal compound on a cellulose acetate film, and this was stuck to the opposite side of this polarizing film so that the cellulose acetate film was on the polarizing film side, using a 3% by mass aqueous solution of PVA (Kuraray Co., Ltd., PVA-117H) as adhesive. In this way, the visual recognition side polarizing plates (PA-01), (PA-02) and (PB-02) were manufactured.

Manufacture of Visual Recognition Side Polarizing Plate (PC-01)

First, a polarizing film was manufactured by adsorbing iodine on an extended polyvinyl alcohol film. Saponification treatment was given to a triacetyl cellulose film (Fuji Photo Film Co., Ltd., Fujitack TD 80U), and this was stuck to one side of this polarizing film, using a 3% by mass aqueous solution of PVA (Kuraray Co., Ltd., PVA-117H) as adhesive. At the same time, saponification treatment was given to an optical compensation film WV A 12B (Fuji Photo Film Co., Ltd.) comprising an optically anisotropic layer of a discotic liquid crystal compound on a cellulose acetate film, and this was stuck to the opposite side of this polarizing film so that the cellulose acetate film was on the polarizing film side, using a 3% by mass aqueous solution of PVA (Kuraray Co., Ltd., PVA-117H) as adhesive. In this way, the visual recognition side polarizing plate (PC-01) was manufactured.

Manufacture of Backlight Side Polarizing Plate (BB-02)

First, a polarizing film was manufactured by adsorbing iodine on an extended polyvinyl alcohol film. Saponification treatment was given to a triacetyl cellulose film (Fuji Photo Film Co., Ltd., FUJITAC TD 80U), and this was stuck to one side of this polarizing film, using a 3% by mass aqueous solution of PVA (Kuraray Co., Ltd., PVA-117H) as adhesive. At the same time, saponification treatment was given to an optical compensation film WV A 12B (Fuji Photo Film Co., Ltd.) comprising an optically anisotropic layer of a discotic liquid crystal compound on a cellulose acetate film, and this was stuck to the opposite side of this polarizing film so that the cellulose acetate film was on the polarizing film side, using a 3% by mass aqueous solution of PVA (Kuraray Co., Ltd., PVA-117H) as adhesive. In this way, the backlight side polarizing plate (BB-02) was manufactured.

### EXAMPLE 1

Manufacture of Liquid Crystal Display

The pair of polarizing plates provided in the liquid crystal display (TH-14TA3, Matsushita Electric Industrial Co., Ltd.) using a TN type liquid crystal cell were peeled off, and instead, the visual recognition side polarizing plate (PB-02) on the observer side, and a backlight side polarizing plate on the backlight side, were respectively stuck via an adhesive so that the optical compensation film was on the liquid crystal cell side. The transmission axis of the polarizing plate on the observer side and the transmission axis of the polarizing plate on the backlight side were disposed in the 0 mode. “MFZ-2555” (LUMISTY, Sumitomo Chemical Co., Ltd.) as an anisotropic scattering film was also disposed between the backlight and liquid crystal cell so that its scattering anisotropy corresponded to the up/down direction of the liquid crystal display.

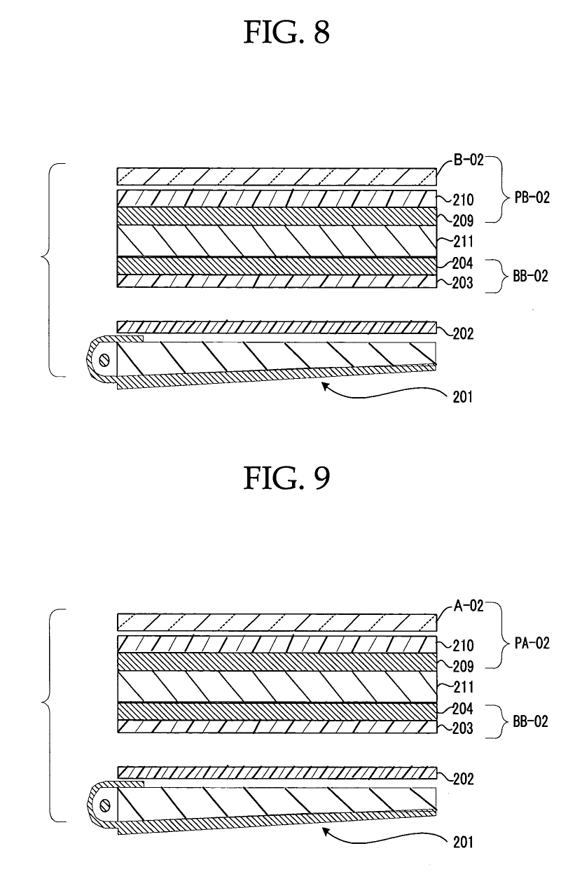

The construction of the liquid crystal display of Example 1 is shown in FIG. 8. In FIG. 8, 201 is a back light unit, 202 is an anisotropic scattering film, 203 is a polarizing film, 204 is an optically anisotropic layer, 209 is an optically anisotropic layer, 210 is a polarizing film, 211 is a liquid crystal cell, and B-02 is an optical diffusion film, respectively.

### EXAMPLE 2

Manufacture of Liquid Crystal Display

The liquid crystal display of Example 2 was manufactured exactly as in Example 1, except that in Example 1, the visual recognition side polarizing plate (PB-02) was replaced by the visual recognition side polarizing plate (PA-02). The construction of the liquid crystal display of Example 2 is shown in FIG. 9. In FIG. 9, 201 is a back light unit, 202 is an anisotropic scattering film, 203 is a polarizing film, 204 is an optically anisotropic layer, 209 is an optically anisotropic layer, 210 is a polarizing film, 211 is a liquid crystal cell, and A-02 is an optical diffusion film, respectively.

### EXAMPLE 3

Manufacture of Liquid Crystal Display

The liquid crystal display of Example 3 was manufactured exactly as in Example 1, except that in Example 1, the visual recognition side polarizing plate (PB-02) was replaced by the visual recognition side polarizing plate (PA-01).

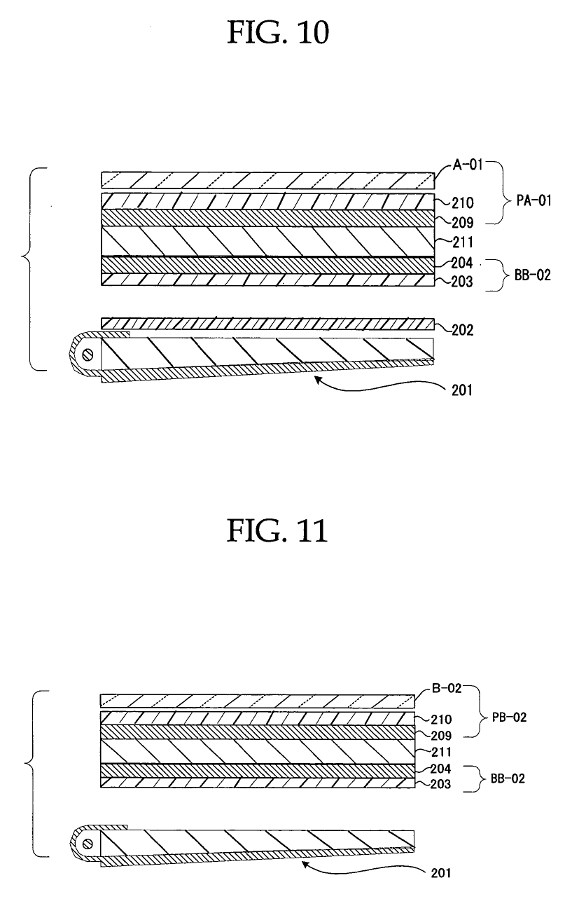

The construction of the liquid crystal display of Example 3 is shown in FIG. 10. In FIG. 10, 201 is a back light unit, 202 is an anisotropic scattering film, 203 is a polarizing film, 204 is an optically anisotropic layer, 209 is an optically anisotropic layer, 210 is a polarizing film, 211 is a liquid crystal cell, and A-01 is an optical diffusion film, respectively.

### COMPARATIVE EXAMPLE 1

Manufacture of Liquid Crystal Display

The liquid crystal display of Comparative Example 1 was manufactured exactly as in Example 1, except that in Example 1, the anisotropic scattering film was not disposed between the backlight and liquid crystal cell.

The construction of the liquid crystal display of Comparative Example 1 is shown in FIG. 11. In FIG. 11, 201 is a back light unit, 203 is a polarizing film, 204 is an optically anisotropic layer, 209 is an optically anisotropic layer, 210 is a polarizing film, 211 is a liquid crystal cell, and B-02 is an optical diffusion film, respectively.

### COMPARATIVE EXAMPLE 2

Manufacture of Liquid Crystal Display

The liquid crystal display of Comparative Example 2 was manufactured exactly as in Example 1, except that in Example 1, the anisotropic scattering film was not disposed between the backlight and liquid crystal cell, and the visual recognition side polarizing plate (PB-02) was replaced by the visual recognition side polarizing plate (PA-02).

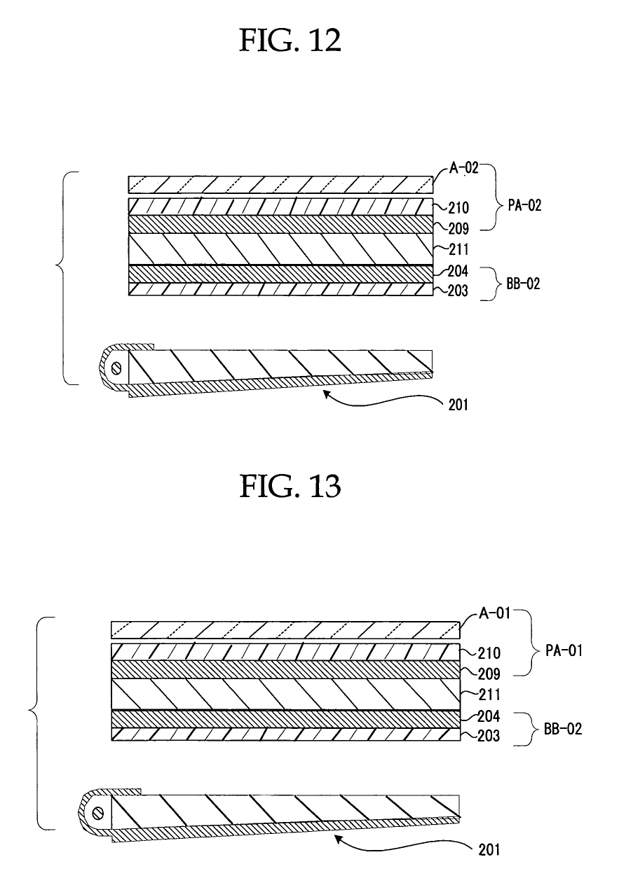

The construction of the liquid crystal display of Comparative Example 2 is shown in FIG. 12. In FIG. 12, 201 is a back light unit, 203 is a polarizing film, 204 is an optically anisotropic layer, 209 is an optically anisotropic layer, 210 is a polarizing film, 211 is a liquid crystal cell, and A-02 is an optical diffusion film, respectively.

### COMPARATIVE EXAMPLE 3

Manufacture of Liquid Crystal Display

The liquid crystal display of Comparative Example 3 was manufactured exactly as in Example 1, except that in Example 1, the anisotropic scattering film was not disposed between the backlight and liquid crystal cell, and the visual recognition side polarizing plate (PB-02) was replaced by the visual recognition side polarizing plate (PA-01).

The construction of the liquid crystal display of Comparative Example 3 is shown in FIG. 13. In FIG. 13, 201 is a back light unit, 202 is an anisotropic scattering film, 203 is a polarizing film, 204 is an optically anisotropic layer, 209 is an optically anisotropic layer, 210 is a polarizing film, 211 is a liquid crystal cell, and A-01 is an optical diffusion film, respectively.

### COMPARATIVE EXAMPLE 4

Manufacture of Liquid Crystal Display

The liquid crystal display of Comparative Example 4 was manufactured exactly as in Example 1, except that in Example 1, the visual recognition side polarizing plate (PB-02) was replaced by the visual recognition side polarizing plate (PC-01), and the anisotropic scattering film (LUMISTY) was disposed via an adhesive also on the visual recognition side of the visual recognition side polarizing plate (PC-01).

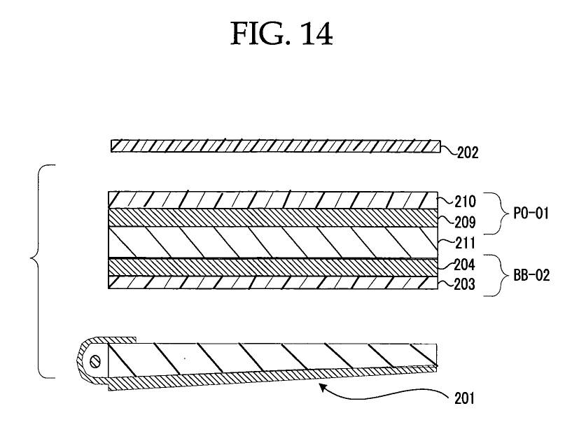

The construction of the liquid crystal display of Comparative Example 4 is shown in FIG. 14. In FIG. 14, 201 is a back light unit, 203 is a polarizing film, 204 is an optically anisotropic layer, 209 is an optically anisotropic layer, 210 is a polarizing film, 211 is a liquid crystal cell, and 202 is an anisotropic scattering film, respectively.

Next, the visual angle and fluorescent lamp reflection were evaluated as follows for the liquid crystal displays of Examples 1 to 3 and Comparative Examples 1 to 4. The results are shown in Table 3.

<Visual Angle Measurement>

For each manufactured liquid crystal display, the visual angle was measured in eight levels from black (L0) to white (L7) using a measurement device (EZ-Contrast 160D, ELDIM).

<Fluorescent Lamp Reflection>

The manufactured liquid crystal displays were placed in a bright room, and fluorescent lamp reflection was evaluated according to the following criteria:

[Evaluation Criteria]

◯ . . . Fluorescent lamp tubes are completely invisible.
Δ . . . Fluorescent lamp tubes are slightly visible.

x . . . Fluorescent lamp tubes are clearly reflected.

TABLE 3

| | Downward | Visual | Visual field | Visual field | |
|---|---|---|---|---|---|
| | gray-scale | field | angle | angle | Reflec- |
| | inversion angle | angle (top) | bottom | (left-right) | tion |
| Example 1 | 63° | 80° | 56° | 160° | ◯ |
| Example 2 | 80° | 80° | 56° | 160° | ◯ |
| Example 3 | 80° | 80° | 56° | 160° | Δ |
| Comp. Ex. 1 | 43° | 70° | 42° | 133° | ◯ |
| Comp. Ex. 2 | 52° | 80° | 48° | 148° | ◯ |
| Comp. Ex. 3 | 52° | 80° | 48° | 148° | Δ |
| Comp. Ex. 4 | 60° | 80° | 48° | 160° | X |

From the results of Table 3, comparing Example 1 and Comparative Example 1, the two differ only in whether or not the anisotropic scattering film is disposed between the backlight and liquid crystal cell, and the same satisfactory level is attained for reflection properties, however it is seen that in Example 1 as compared to Comparative Example 1, the downward gray scale inversion angle of the liquid crystal panel is largely improved.

Comparing Example 2 and Comparative Example 2, the two differ only in whether or not an optical diffusion film whereof the scattered light intensity ratio at 30°/0° of the optical diffusion film on the visual recognition side of the liquid crystal cell is 0.01% or more, is used, and an anisotropic scattering film is disposed between the backlight and liquid crystal cell. The same satisfactory level is attained for reflection properties, however it is seen that in Example 2 as compared to Comparative Example 2, the downward gray scale inversion angle of the liquid crystal panel is largely improved.

Comparing Example 3 and Comparative Example 3, the two differ only in whether or not an anisotropic scattering film is disposed between the backlight and liquid crystal cell, however it is seen that in Example 3 as compared to Comparative Example 3, the downward gray scale inversion angle of the liquid crystal panel is largely improved. In both cases, a low refractive index layer is not provided on the optical diffusion film used on the visual recognition side, so fluorescent lamp tubes are slightly reflected and display quality slightly deteriorates.

In Comparative Example 4, the optical anisotropic scattering film is disposed on the surface of the visual recognition side polarizing plate, which is an identical construction to that of the liquid crystal display of the prior art disclosed in JP-A No. 2002-90527, so the gray scale inversion angle in the downward direction of the liquid crystal panel is improved, but the downward gray scale inversion angle is narrower than those in Examples 1 to 3, the fluorescent lamp tubes are clearly reflected, and display quality deteriorates.

According to the present invention, the problems inherent in the prior art can be resolved, and by disposing the anisotropic scattering film between the backlight and liquid crystal cell, by selectively scattering light at an angle at which gray scale inversion of the liquid crystal cell occurs, incident light at the angle at which gray scale inversion occurs is relatively suppressed, and due to the optical diffusion film provided on the visual recognition side of the liquid crystal cell, by scattering light for which gray scale inversion does not occur, gray scale inversion Is largely improved, visual field angle properties are largely improved, stray light reflection is prevented, and, thus, a transmitting type liquid crystal display having improved front contrast and image clarity, can be provided.

1. A liquid crystal display, comprising:
a backlight;
an anisotropic scattering film having different scattering properties depending on incident angles;
a liquid crystal cell comprising liquid crystals sandwiched between two facing substrates;
polarizing plates respectively disposed on the backlight side and visual recognition side of the liquid crystal cell; and
at least one optical diffusion film on the visual recognition side of the liquid crystal cell, wherein a difference H(θ)−H(0) between the haze H(θ) of the anisotropic scattering film for incident light at a gray scale inversion angle θ of the liquid crystal cell, and the haze H(0) of the anisotropic scattering film for incident light from the normal direction of the anisotropic scattering film is 5% to 100%, and the anisotropic scattering film is disposed between the backlight and the liquid crystal cell.

2. The liquid crystal display according to claim 1, wherein the difference H(θ)−H(0) is 15% to 100%.

3. The liquid crystal display according to claim 1, wherein the anisotropic scattering film comprises a structure with a non-uniform refractive index.

4. The liquid crystal display according to claim 1, wherein the optical diffusion film is disposed on the uppermost surface on the visual recognition side of the liquid crystal cell.

5. The liquid crystal display according to claim 1, wherein the scattered light intensity at 30° relative to the light intensity at an emission angle of 0° in the scattered light angle distribution of the optical diffusion film is 0.01% to 0.2%, and the haze H(0) in the optical diffusion film is 40% or more.

6. The liquid crystal display according to claim 1, wherein the scattered light intensity at 60° relative to the light intensity at an emission angle of 0° in the scattered light angle distribution of the optical diffusion film is 0.02% or less.

7. The liquid crystal display according to claim 1, wherein the surface of the optical diffusion film comprises a low refractive index layer having a refractive index of 1.35 to 1.45.

8. The liquid crystal display according to claim 1, wherein the optical diffusion film comprises a substrate, an optical diffusion layer disposed on the substrate, and a low refractive in this order.

9. The liquid crystal display according to claim 8, wherein the optical diffusion layer comprises two or more kinds of optically transmitting particles whereof at least one of the refractive index and volume-weighted average particle diameter is different in the optically transmitting resin.

10. The liquid crystal display according to claim 8, wherein a thickness of the optical diffusion layer is 0.5 μm to 50 μm.

11. The liquid crystal display according to claim 8, wherein an average value of mirror reflectivity at 5° incidence of the low refractive index layer in a wavelength region of 450 nm to 650 nm, is 2.5% or less.

12. The liquid crystal display according to claim 1, wherein polarizing plates comprise a polarizing film and protective films disposed on both sides of the surface of the polarizing film.

13. The liquid crystal display according to claim 12, wherein polarizing plates further comprise an optically anisotropic layer, and the optically anisotropic layer comprises a liquid crystal compound.

14. The liquid crystal display according to claim 1, wherein the liquid crystal cell is one selected from a TN mode, OCB mode and ECB mode.

15. The liquid crystal display according to claim 1, wherein the backlight is a sidelight type backlight using a cold cathode tube lamp.

16. The liquid crystal display according to claim 1, wherein the liquid crystal display is a transmitting type.
